(19) United States
(12) Patent Application Publication
(10) Pub. No.: US 2026/0168406 A1
(43) Pub. Date: Jun. 18, 2026

(54) GAS TURBINE ENGINE WASH SYSTEMS AND METHODS

(71) Applicant: General Electric Company, Evendale, OH (US)

(72) Inventors: Ambarish Jayant Kulkarni, Glenville, NY (US); Andrew Crispin Graham, Badminton (GB); Byron A. Pritchard, JR., Loveland, OH (US); Michael E. Eriksen, Milford, OH (US); Keith Anthony Lauria, Wells, NY (US); Frank Nicholas Ricciardi, Cincinnati, OH (US); Michael J. Gundrum, West Chester, OH (US); Rachel Marie Sorell, Albany, NY (US)

(21) Appl. No.: 19/416,281

(22) Filed: Dec. 11, 2025

Related U.S. Application Data
(60) Provisional application No. 63/733,526, filed on Dec. 13, 2024.

(51) Int. Cl. F01D 25/00; B08B 3/00; B08B 3/04

(52) U.S. Cl. CPC F01D 25/002; B08B 3/003; B08B 3/04

(57) ABSTRACT

A wash system may include an inlet assembly comprising a first fluid conduit defining a first fluid passageway for delivering a gas and a second fluid conduit defining a second fluid passageway for delivering a liquid. The system may include a delivery nozzle that is coupled to the inlet assembly, the delivery nozzle comprising at least one outlet opening. The system may include a plurality of valves to control fluid flow into the delivery nozzle, the plurality of valves including a first valve in the first fluid passageway and a second valve in the second fluid passageway. The system may include a controller configured to actuate the plurality of valves to cause the wash system to switch between a foam washing mode and a liquid washing mode, wherein the delivery nozzle delivers a foam in the foam washing mode and delivers atomized liquid in the liquid washing mode.

### CROSS REFERENCE TO RELATED APPLICATION

This application claims the benefit of U.S. Provisional Application No. 63/733,526, filed Dec. 13, 2024, which is incorporated herein by reference in its entirety.

### TECHNICAL FIELD

These teachings relate generally to wash systems for a gas turbine engine and a method of operating the same.

### BACKGROUND

Gas turbine engines can accumulate a significant amount of dust and debris during operation. In some scenarios, gas turbine engines and engine components accumulate large layers of dust deposits that may have an effect on operation. Dust deposits can enter an engine during operation and can block engine components, reducing engine performance as a result. In some examples, an accumulation of dust deposits may cause internal damage to an engine if left. Accordingly, it may be desirable to have gas turbine engine wash systems capable of removing dust deposits.

### BRIEF DESCRIPTION OF DRAWINGS

Various needs are at least partially met through provision of the gas turbine engine wash system and methods described in the following detailed description, particularly when studied in conjunction with the drawings. A full and enabling disclosure of the aspects of the present description, including the best mode thereof, directed to one of ordinary skill in the art, is set forth in the specification, which refers to the appended figures, in which:

FIG. 1 is a schematic diagram of a wash system that generates foam in-situ, in accordance with various embodiments of these teachings;

FIGS. 2A and 2B are schematic diagrams of a wash apparatus that can be used in the wash system of FIG. 1, according to a first embodiment;

FIGS. 3A and 3B are schematic diagrams of a wash apparatus that can be used in the wash system of FIG. 1, according to a second embodiment;

FIGS. 4A and 4B are schematic diagrams of a wash apparatus that can be used in the wash system of FIG. 1, according to a third embodiment;

FIG. 5 is a schematic diagram of a wash system that generates foam in-situ, in accordance with various embodiments of these teachings;

FIGS. 6A and 6B are schematic diagrams of a wash apparatus that can be used in the wash system of FIG. 5, according to a first embodiment;

FIGS. 7A and 7B are schematic diagrams of a wash apparatus that can be used in the wash system of FIG. 5, according to a second embodiment;

FIG. 8 is a schematic diagram of a wash system that ingests foam from an external source, in accordance with various embodiments of these teachings;

FIGS. 9A and 9B are schematic diagrams of a wash apparatus that can be used in the wash system of FIG. 8, according to a first embodiment;

FIGS. 10A, 10B, 10C, and 10D are schematic diagrams of a delivery nozzle that can be used in the wash system of FIG. 8, according to a second embodiment;

FIGS. 11A, 11B, and 11C are schematic diagrams of a delivery nozzle that can be used in the wash system of FIG. 8, according to a third embodiment;

FIGS. 12A and 12B are schematic diagrams of a wash apparatus that can be used in the wash system of FIG. 8, according to a fourth embodiment;

FIGS. 13A, 13B, and 13C are schematic diagrams of a wash apparatus that can be used in the wash system of FIG. 8, according to a fifth embodiment;

FIGS. 14A and 14B are schematic diagrams of a wash apparatus that can be used in the wash system of FIG. 8, according to a sixth embodiment;

FIGS. 15A and 15B are schematic diagrams of a wash apparatus that can be used in the wash system of FIG. 8, according to a seventh embodiment; and

FIG. 16 is a schematic diagram of an exemplary system that can be used with the wash systems of FIG. 1, FIG. 5, and FIG. 8 in accordance with various embodiments of these teachings.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present teachings. Also, common but well-understood elements that are useful or necessary in a commercially feasible embodiment are often not depicted in order to facilitate a less obstructed view of these various embodiments of the present teachings. Certain actions and/or steps may be described or depicted in a particular order of occurrence while those skilled in the art will understand that such specificity with respect to sequence is not actually required.

### DETAILED DESCRIPTION

Current wash systems for gas engines take a significant amount of time cleaning to achieve a desired level of cleanliness. Further, current methods often involve engine rotation or operation during cleaning to release built up dust within the engine. This decreases efficiency during cleaning as the engine is operated after an initial wash to release dust, and a secondary wash may also be performed after operation in order to remove the released dust. These are significant challenges in the context of aviation application settings.

In some embodiments, the wash systems described herein may be in the form of a tooling system comprising gas and liquid delivery systems. The tooling system may be a dual function insertion tool having the ability to generate foam within the insertion tool and having the ability to deliver a steady high-pressure liquid stream and/or a liquid droplet delivery. The pulsed liquid droplet delivery is achieved in the present disclosure by cycling between a liquid fill phase and an air pulse to accelerate and/or atomize the liquid into droplets. The wash systems further balance a chemical cleaning flow, fluid temperature, and duration of flow in order to loosen deposits which would be followed by a high-pressure erosive liquid flow to remove deposits. Further, the wash systems may remove loose debris particles to allow liquid to reach larger deposits more effectively.

Generally speaking, the various aspects of the present disclosure can be employed with a wash system including an inlet assembly comprising multiple conduits for delivering multiple fluid sources, a delivery nozzle coupled to the inlet assembly, and a plurality of valves to control the fluid flow from the conduits into the delivery nozzle. The wash system may include a controller configured to actuate the valves which causes the wash system to switch between a foam washing mode delivering foamed washing liquid and a liquid washing mode delivering high-pressure/atomized liquid. The wash systems of the present disclosure increase efficiency and decrease the duration of time and complexity required during cleaning of an engine and/or engine component. For example, cycling foam washing with liquid washing may achieve complete or near complete removal of contaminant deposits in a shorter amount of time compared with using either foam washing or liquid washing (e.g., washing using a pressurized and/or an atomized liquid) alone. It is contemplated, for example, that first subjecting contaminant deposits to foam washing may result in sharper edged deposits and/or may weaken the contaminant deposit making the contaminant more susceptible to liquid washing.

It is contemplated that using a foam washing cycle in combination with a liquid washing cycle may achieve removal of contamination deposits from an internal structure of a gas turbine engine in a shorter amount of time when compared with using foam washing or liquid washing alone. Thus, the wash systems and methods described herein may result in more efficient and faster cleaning, a reduced cycle time for cleaning the gas turbine engine and may allow the engine to be returned to service in a shorter amount of time. During engine operation, a contaminant deposit, such as dust, may build up on an internal structure of a gas turbine engine, such as a blade. After a foam washing cycle, contaminant deposits may have a sharper edge that may be more susceptible to effective liquid washing. For example, after foam washing, the contaminant deposits may be levered off of the internal structure. Foam washing may also help to weaken the contaminant deposits making removal via liquid washing more effective. Further, foam washing may loosen an interface between the contaminant deposit and a surface of the internal structure such that the application of force via liquid washing results in removal of most or an entirety of the contaminant deposit, resulting in a reduced cleaning time.

As used herein, an “atomized” liquid may refer to a liquid that has been broken down into small droplets. In some aspects, the droplets in an atomized liquid may be greater than about 30 microns.

As used herein, “low-pressure” may refer to pressures in the range of about 2 pounds per square inch (psi) to about 50 psi. For example, a low-pressure gas may be at a pressure in the range of about 2 psi to 50 psi.

As used herein, “high-pressure” may refer to pressures of at least 50 psi and, in some aspects, pressures in the range of about 100 psi to about 5000 psi or in the range of about 50 psi to about 300 psi. In some examples, a high-pressure liquid is at a pressure in the range of about 100 psi to 5000 psi. In some examples, a high-pressure gas is at a pressure in the range of about 50 psi to about 300 psi.

### In-situ Foam Generation—Within Inlet Assembly

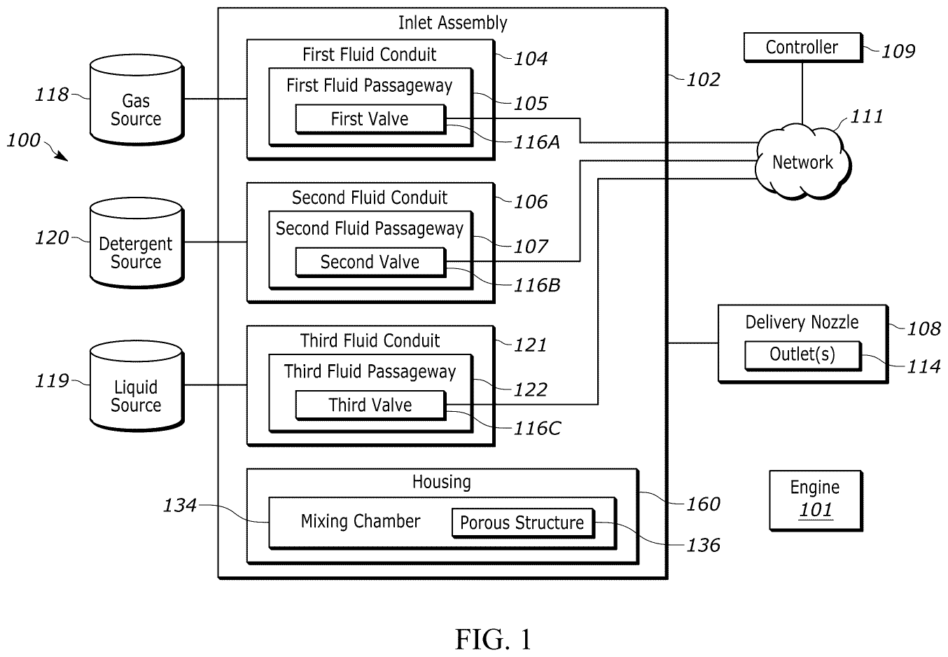

Referring now to the drawings, FIG. 1 illustrates a wash system 100. It is generally contemplated that the wash system 100 generates a foam in-situ or within the wash system 100. Specifically, the wash system 100 generates foam within an inlet assembly 102 and delivers the foam to a delivery nozzle 108. The wash system 100 can be operated to wash a variety of components such as an engine 101 or portions thereof. In some embodiments, the engine 101 is a gas turbine engine. The wash system 100 includes the inlet assembly 102 which is configured to control the delivery of a gas, a liquid, and a detergent to the delivery nozzle 108. The wash system 100 further includes a plurality of valves including a first valve 116A for controlling flow of the gas to the delivery nozzle 108, a second valve 116B for controlling flow of the detergent to the delivery nozzle 108, and third valve 116C for controlling flow of the liquid to the delivery nozzle 108. Together, the first valve 116A, the second valve 116B, and the third valve 116C may also be referred to herein as a “valve system.”

During a cleaning operation using the wash system 100, the delivery nozzle 108 can be inserted through one or more access ports in the engine 101. For example, the delivery nozzle 108 can be inserted through an access port that is in fluid communication with an engine core (e.g., a compressor section, combustor, and/or turbine section of the engine). In some examples, the access port can be an inlet to the core section of the engine. In other examples, the access port can be an inspection port such as a borescope inspection port(s) that may allow for inspection of the engine 101 between operations and may open into the core air flow path of the engine 101. The access port(s), for example, can be defined in the compressor section, combustor, and/or turbine section of the engine 101. The access port(s) may allow for inspection of the engine 101, for example, to allow for inspection or servicing of one or more blades, nozzles, combustion liners, and/or other components of the engine 101 between operations.

In the wash system 100, a controller 109 is in operative communication with the plurality of valves 116A, 116B, 116C to control the flow of the gas, the detergent, and the liquid in the wash system 100. Further, to generate foam within the wash system 100, the inlet assembly 102 includes a mixing chamber 134. The mixing chamber 134 includes a porous structure 136 disposed therein for aerating the detergent. The controller 109 is operable to select between a foam washing mode and a liquid washing mode for the wash system 100 by operating the plurality of valves 116A, 116B, 116C.

The porous structure 136 can be any structure with void space sufficient to generate turbulent flow in a liquid flowing therethrough to facilitate aeration of the liquid. In some approaches, the porous structure 136 has a flow area that is reduced by 50% by random strands of a mesh along at least one length. In some approaches, the porous structure 136 is an air stone or similar diffusing element. The porous structure 136 can be made from porous stone, ceramic beads, glass beads, rubber, or various porous synthetic materials.

Turning to the various components of the wash system 100, the inlet assembly 102 includes a first fluid conduit 104. The first fluid conduit 104 defines a first fluid passageway 105 for delivering the gas to the delivery nozzle 108. The first fluid conduit 104 may be any suitable pipe, hose, tube, vessel, and so forth, which defines a fluid passageway through which a fluid may flow. The first fluid conduit 104 is in fluid communication with a gas source 118. The gas source 118 delivers any suitable gas into the first fluid conduit 104. In some forms, the gas includes at least one of air or an inert gas such as nitrogen. In some embodiments, the gas source 118 includes at least one of a gas storage tank, a plant air system, a nitrogen system, or a compressor. In some embodiments, one or more of the gas storage tank or the compressor are disposed on a mobile cart for transportation. The first valve 116A is disposed in the first fluid passageway 105. Generally, gas is delivered from the gas source 118 through the first fluid passageway 105 of the first fluid conduit 104 and into the delivery nozzle 108 when the first valve 116A is in an open state.

The inlet assembly 102 also includes a second fluid conduit 106 defining a second fluid passageway 107 for delivering the detergent to the delivery nozzle 108. The second fluid conduit 106 may be any suitable pipe, hose, tube, vessel, and so forth, which defines a fluid passageway through which a fluid may flow. The second fluid conduit 106 is in fluid communication with a detergent source 120. The detergent source 120 delivers any suitable detergent into the second fluid conduit 106. The detergent can be any suitable detergent. The detergent can include at least one or an organic acidic component or a surfactant. The detergent can include one or more organic acidic components and/or one or more surfactants. In some embodiments, the detergent source 120 includes a detergent tank operatively coupled to a pump for delivering the detergent. In further embodiments, the detergent tank may be disposed on a mobile cart for transportation. The second valve 116B is disposed in the second fluid passageway 107. Generally, detergent is delivered from the detergent source 120 through the second fluid passageway 107 of the second fluid conduit 106 and into the delivery nozzle 108 when the second valve 116B is in an open state.

The inlet assembly 102 also includes a third fluid conduit 121. The third fluid conduit 121 defines a third fluid passageway 122 for delivering a liquid to the delivery nozzle 108. The third fluid conduit 121 may be any suitable pipe, hose, tube, vessel, and so forth, which defines a fluid passageway through which a fluid may flow. The third fluid conduit 121 is in fluid communication with a liquid source 119. In some forms, the liquid is water or a hydrocarbon solvent, though any suitable cleaning liquid can be used. In some embodiments, the liquid source 119 includes a liquid tank operatively coupled to a pump for delivering the liquid. In further embodiments, the liquid tank may be disposed on a mobile cart for transportation. The third valve 116C is disposed in the third fluid passageway 122. Generally, liquid is delivered from the liquid source 119 through the third fluid passageway 122 of the third fluid conduit 121 and into the delivery nozzle 108 when the third valve 116C is in an open state.

As illustrated, the plurality of valves 116A, 116B, 116C in the inlet assembly 102 are operatively coupled to the controller 109. The controller 109 is communicatively coupled to the valve system over a network 111. The controller 109 is configured to switch between a foam washing mode and a liquid washing mode by operating or actuating the plurality of valves 116A, 116B, 116C. Each of the plurality of valves 116A, 116B, 116C can be actuated between an open and closed position using the controller 109. The valves 116A, 116B, 116C, however, may be actuated by any suitable combination of manual (i.e., directly actuated by an operator) or automated (i.e., actuated by a motorized mechanism) mechanisms. In some forms, automated mechanisms may be controllable by an operator. In some embodiments, the controller 109 can adjust at least one of a pressure or a flow rate of the gas via the first valve 116A. In some embodiments, the controller 109 can adjust a flow rate of the detergent via the second valve 116B. In some embodiments, the controller 109 can adjust a flow rate of the liquid via the third valve 116C.

In some embodiments, in the foam washing mode, the controller 109 can change the type of foam generated, for example, by varying flow rate of the gas in the first fluid passageway 105 by adjusting the first valve 116A and by varying flow rate of the detergent in the second fluid passageway 107 by adjusting the second valve 116B.

In some embodiments, one of the sources 118, 119, 120 may provide a constant fluid flow into a conduit requiring a valve to control the flow of fluid out of the conduit. In some embodiments, a fluid source may be controllable such that a fluid flow into a conduit is non-constant and the fluid flow out of the conduit is controllable directly from the fluid source. In such an embodiment, a conduit may not include a valve within a respective passageway to control the flow of a fluid into the delivery nozzle 108.

The inlet assembly 102 also includes a housing 160 that defines the mixing chamber 134. The mixing chamber includes a porous structure 136 for foam generation. The porous structure 136 aids foam generation by aerating the detergent in the foam washing mode. In particular, the porous structure 136 and the mixing chamber 134 may be configured to generate the foamed cleaning fluid in the foam washing mode. Further the porous structure 136 may aid in aerating or, in some aspects, atomizing the liquid in the liquid washing mode.

The delivery nozzle 108 is in fluid communication with the inlet assembly 102. The delivery nozzle 108 includes at least one outlet opening 114. The outlet openings 114 are configured to output any combination of the fluids from sources 118, 119, 120 from the delivery nozzle 108. The outlet openings 114 may have any suitable number, shape, spacing, and/or configuration. In some embodiments, the outlet openings 114 may be in the form of multiple uniformly spaced and/or uniformly sized outlet openings 114, while in some embodiments the outlet openings 114 may not be uniformly spaced and/or sized. It is generally contemplated that any side and/or surface of the delivery nozzle 108 may include the at least one outlet opening 114 such that the fluid output from the delivery nozzle 108 is output from the wash system 100. Generally, the fluid output from the wash system 100 via the at least one outlet opening 114 is directed to aircraft components, such as internal structures of a gas turbine engine, for cleaning of the components.

In operation, the plurality of valves 116A, 116B, 116C are configured to control the flow of the gas, the detergent, and the liquid to the delivery nozzle 108. The controller 109 operates or actuates the plurality of valves 116A, 116B, 116C to select between the foam washing mode and the liquid washing mode. In the foam washing mode the delivery nozzle 108 delivers a foam for cleaning. To deliver a foam, in the foam washing mode, the first valve 116A and the second valve 116B are in the open position and the third valve 116C is in the closed position. When the valves are so configured, the gas flows through the first fluid passageway 105 and the detergent flows through the second fluid passageway 107. The gas and the detergent are mixed and/or aerated in the mixing chamber 134 to generate the foam. The foam is delivered through the delivery nozzle 108. In the liquid washing mode, the first valve 116A and the second valve 116B are in the closed position and the third valve 116C is in the open position. When the valves are so configured, the liquid flows through the third fluid passageway 122 and passes through the mixing chamber 134 to the delivery nozzle 108. Generally, the liquid is in the form of an erosive stream which hits the component of the gas turbine engine being washed (e.g., a high-pressure compressor blade). In some embodiments, in the liquid washing mode, the liquid has a pressure greater than 1500 psi. In some embodiments, in the liquid washing mode, the liquid has a droplet size of greater than 30 microns.

In some embodiments, the controller 109 may be pre-programmed to operate the wash system 100 in the foam washing mode and/or the liquid washing mode for a pre-determined amount of time (e.g., a predetermined cycle time). For example, the controller 109 may operate the wash system 100 in the foam washing mode for a set amount of time before switching to the liquid washing mode. In addition, the controller 109 may be pre-programmed to carry out any number (e.g., a predetermined number) of foam washing and/or liquid washing cycles.

In some embodiments, a flow rate of the foam in the foam washing mode is in the range of about 0.01 gallons per minute to 0.08 gallons per minute, and a flow rate of the liquid in the liquid washing mode is in a range of about 0.5 gallons per minute to 7 gallons per minute. While the ranges provided are preferred ranges, it is generally understood that any alternate range of foam flow rate and/or liquid flow rate may be used as suitable for a specified application.

Subsequent figures illustrate various configurations of wash assemblies that can be used in conjunction with the wash system 100. The wash assemblies are configured for in-situ foam generation within the inlet assembly 102.

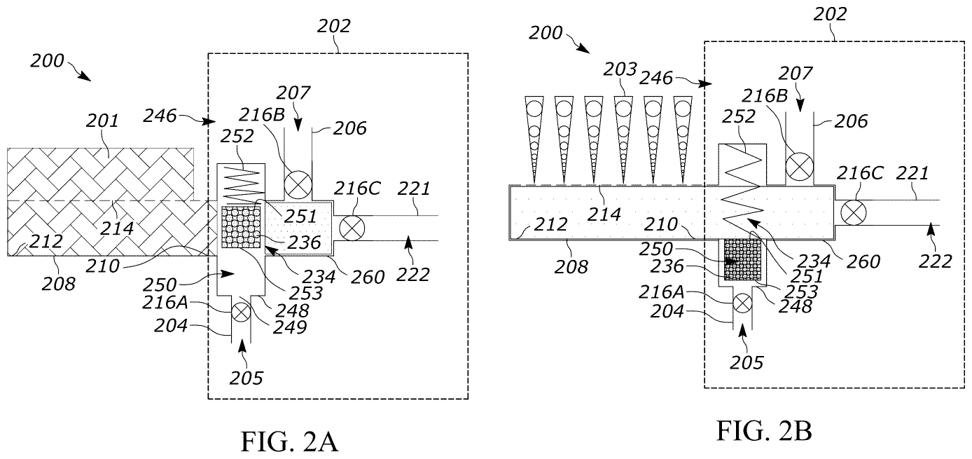

FIGS. 2A and 2B illustrate a wash apparatus 200 that can be used in the wash system 100, according to a first embodiment. The wash apparatus 200 can generate foam in-situ within an inlet assembly that is upstream of a delivery nozzle. The wash apparatus 200 includes an inlet assembly 202 and a delivery nozzle 208 positioned downstream of the inlet assembly 202. The inlet assembly 202 includes a pressure operated valve assembly 246 that translates a porous structure 236 between a first position for a foam washing mode (see FIG. 2A) and a second position for a liquid washing mode (see FIG. 2B). In some embodiments, the wash apparatus 200 delivers a pressurized liquid (e.g., a high-pressure liquid) in the liquid washing mode. It is contemplated that the wash apparatus 200 can be used in the wash system 100 of FIG. 1. Namely, the controller 109 of FIG. 1 can be used to operate the wash apparatus 200 and switch between the foam washing mode and the liquid washing mode. In the foam washing mode (FIG. 2A), the foam 201 is generated within the inlet assembly 202 via the porous structure 236 and delivered to the delivery nozzle 208. In the liquid washing mode (FIG. 2B), a liquid 203 is delivered to the delivery nozzle 208. Elements of the first embodiment that are similar to those in FIG. 1 have been given similar reference numbers in the two-hundred series. For example, the inlet assembly 102 described in FIG. 1 is labeled as the inlet assembly 202 in FIGS. 2A and 2B.

The inlet assembly 202 includes a first fluid conduit 204 defining a first fluid passageway 205 for delivering a gas to the delivery nozzle 208. A first valve 216A is disposed in the first fluid passageway 205 for controlling flow of the gas into the delivery nozzle 208. The inlet assembly 202 also includes a second fluid conduit 206 defining a second fluid passageway 207 for delivering a detergent to the delivery nozzle 208. The inlet assembly 202 also includes a third fluid conduit 221 defining a third fluid passageway 222 for delivering a liquid to the delivery nozzle 208. In some embodiments, the controller 109 of FIG. 1 is in operative communication with the valves 216A, 216B, 216C. In some embodiments, at least one of a pressure or a flowrate of the gas may be adjustable via the first valve 216A. A flow rate of the detergent may be adjustable via the second valve 216B. A flow rate of the liquid may be adjustable via the third valve 216C.

The inlet assembly 202 further includes a housing 260 that defines a mixing chamber 234. The housing 260 may be of any suitable shape and, in some embodiments, is generally cylindrical in shape. The mixing chamber 234 is configured to receive one or more of the gas, the detergent, and the liquid, depending on the operating mode. In the inlet assembly 202, the first fluid conduit 204, the second fluid conduit 206, and the third fluid conduit 221 are coupled to the mixing chamber 234. In this manner, the first fluid passageway 205 is in fluid communication with and delivers the gas to the mixing chamber 234. The second fluid passageway 207 is in fluid communication with and delivers the detergent to the mixing chamber 234. The third fluid passageway 222 is in fluid communication with and delivers the liquid to the mixing chamber 234. The pressure operated valve assembly 246 is disposed in the mixing chamber 234. The pressure operated valve assembly 246 controls foaming of the detergent. The pressure operated valve assembly 246 is operated by a pressure of the gas that is delivered to the mixing chamber 234.

In some embodiments, the second fluid conduit 206 and the third fluid conduit 221 are coupled to the housing 260 upstream of the first fluid conduit 204. In other embodiments, the third fluid conduit 221 is coupled to the housing 260 downstream of the first fluid conduit 204 and the second fluid conduit 206.

Further, in some embodiments, the second fluid conduit 206 and the third fluid conduit 221 are coupled to the housing 260 upstream of the pressure operated valve assembly 246. In other embodiments, the third fluid conduit 221 is coupled to the housing 260 downstream of the pressure operated valve assembly 246.

The pressure operated valve assembly 246 includes a retaining wall 248 with an orifice 249 formed therein, a receiving chamber 250, the porous structure 236, and a biasing member 252. The retaining wall 248 is coupled to the first fluid conduit 204 such that gas exiting the first fluid passageway 205 passes through the orifice 249 and into the mixing chamber 234. The receiving chamber 250 is defined by the retaining wall 248 and a portion of the first fluid conduit 204. The porous structure 236 is translatable into and out of the receiving chamber 250 via the biasing member 252. The porous structure 236 is movable between a first position (FIG. 2A) and a second position (FIG. 2B). In the first position, the porous structure 236 is positioned within the second fluid conduit 206 to increase the flow of the gas into the second fluid conduit 206 which consequently increases foaming of the cleaning liquid. In the second position, the porous structure 236 is seated within the receiving chamber 250 against the retaining wall 248 to decrease the flow of gas into the delivery nozzle 208 and consequently decreasing foaming of the detergent. In some embodiments, an entirety of the porous structure 236 is seated within the receiving chamber 250 in the liquid washing mode.

The biasing member 252 is disposed within the mixing chamber 234 upstream of the delivery nozzle 208. The biasing member 252 is operatively coupled to the porous structure 236. The biasing member 252 biases the porous structure 236 towards the second position. In the second position (see FIG. 2B), the biasing member 252 limits the flow of gas from the first fluid conduit 204 into the mixing chamber 234. In some forms, the second position may be considered a natural state of the biasing member 252, for example, when no external forces are applied to the biasing member 252. Generally, the biasing member 252 has a minimum force required to move the biasing member 252 from the natural state. In the first position (see FIG. 2A), the biasing member 252 is compressed, for example, from the natural state. When a force exerted by gas flowing through the first fluid passageway 205 is greater than the minimum force required to move the biasing member 252, the biasing member 252 moves from the second position to the first position. During operation, the porous structure 236 may assume any intermediate position between the first position and the second position based on the force exerted by the gas from the first fluid passageway 205.

In some embodiments, the biasing member 252 is in the form of a spring. The spring may be any suitable coil spring, leaf spring, torsion spring, and so forth.

The porous structure 236 has a first face 253 disposed adjacent to the retaining wall 248 and a second face 251 disposed opposite the first face 253. In the described embodiment, the biasing member 252 is coupled to the second face 251 of the porous structure 236. The biasing member 252 exerts a force on the second face 251 to bias the porous structure 236 towards the retaining wall 248. In the first position (FIG. 2A), the porous structure 236 is positioned in the mixing chamber 234 and the first face 253 is spaced from the retaining wall 248. In the second position (FIG. 2B), porous structure 236 is positioned in the receiving chamber 250 and the first face 253 is adjacent to the retaining wall 248 and, in some aspects, may contact the retaining wall 248. While the porous structure 236 as illustrated is in the form of a rectangular block, it is generally understood that the porous structure 236 may be any suitable size and/or shape. In some embodiments, the wash apparatus 200 may include any suitable number of porous structures 236.

As illustrated, the second fluid conduit 206 and the third fluid conduit 221 are coupled to the mixing chamber 234 upstream of the pressure operated valve assembly 246. Also, as illustrated, the second fluid conduit 206 and the third fluid conduit 221 are coupled to the mixing chamber 234 upstream of the first fluid conduit 204.

The porous structure 236 may be formed from any suitable material, for example, that is capable of aerating a liquid. In some embodiments, the porous structure 236 is a mesh material. In some embodiments, the porous structure 236 is a sintered metal material. In some embodiments, the porous structure 236 is an additively printed porous structure. In some embodiments, the porous structure 236 is in the form of a mesh block.

The delivery nozzle 208 includes a feed end 210 and a delivery end 212. The delivery nozzle 208 is elongated along a longitudinal axis that runs from the feed end 210 to the delivery end 212. The feed end 210 of the delivery nozzle 208 is coupled to the inlet assembly 202. The delivery end 212 includes at least one outlet opening 214. Any suitable number of outlet openings 214 may be used. Further, the outlet openings 214 may have any suitable size and shape.

In the illustrated embodiment, the pressure operated valve assembly 246 is disposed in the inlet assembly 202. However, in other embodiments, the pressure operated valve assembly 246 can be incorporated into the delivery nozzle 208, for example, in the feed end 210 of the delivery nozzle 208.

In some embodiments, the controller 109 operates the valves 216A, 216B, 216C to place the wash apparatus 200 in the foam washing mode (FIG. 2A) and the liquid washing mode (FIG. 2B).

In the foam washing mode (FIG. 2A), the pressure operated valve assembly 246 generates a foam 201. The first valve 216A is open to permit a flow of gas through the first fluid conduit 204 into the delivery nozzle 208. The second valve 216B is open to permit a flow of detergent through the second fluid conduit 206 into the delivery nozzle 208. The third valve 216C is closed to stop a flow of liquid through the third fluid conduit 221 into the delivery nozzle 208. With the valves so configured, gas and detergent are delivered to the delivery nozzle 208. Further, due to the flow of gas, the gas exerts a force on the first face 253 of the porous structure 236 to move at least a portion of the porous structure 236 out of the receiving chamber 250 and into the mixing chamber 234. The presence of the porous structure 236 in the mixing chamber 234 facilitates foam generation in the mixing chamber 234 and results in aeration of the detergent (e.g., because the detergent and the gas are forced to flow through the porous structure 236).

In the liquid washing mode (FIG. 2B), the pressure operated valve assembly 246 delivers a liquid 203 to the delivery nozzle 208. The first valve 216A is closed to stop a flow of gas through the first fluid conduit 204 into the mixing chamber 234. In addition, the second valve 216B is closed to stop the flow of detergent into the mixing chamber 234 resulting in the porous structure 236 being displaced adjacent to the retaining wall 248 (e.g., because of reduced pressure on the first face 253). The third valve 216C is opened to permit a flow of liquid through the third fluid conduit 221. With the valves so configured, liquid only is delivered to the mixing chamber 234. Further, because there is no gas flow into the mixing chamber 234, the porous structure 236 is seated within the receiving chamber 250 and flow through the mixing chamber 234 is generally unobstructed by the porous structure 236.

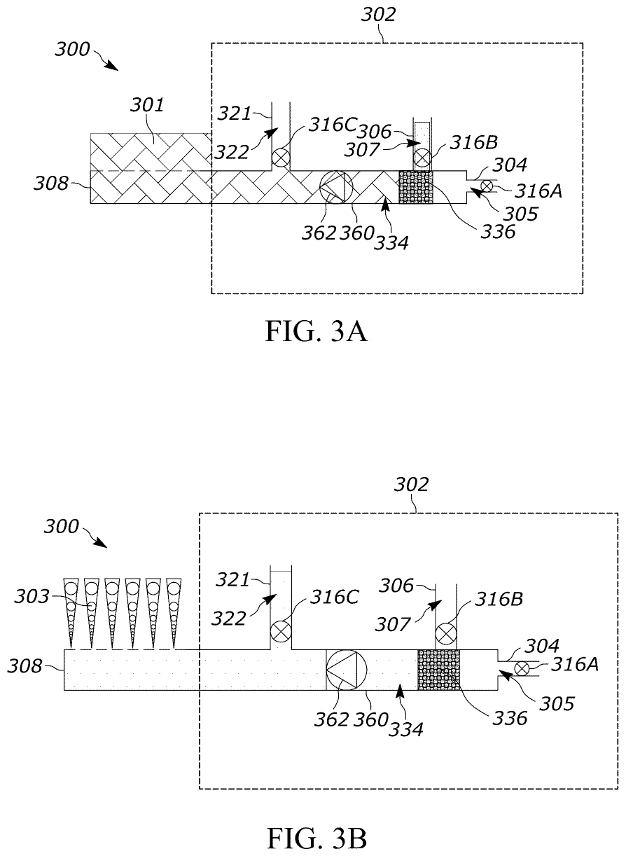

FIGS. 3A and 3B illustrate a wash apparatus 300 that can be used in the wash system 100, according to a second embodiment. The wash apparatus 300 can generate foam in-situ within an inlet assembly that is upstream of a delivery nozzle. In operation, the wash apparatus 300 may switch between a foam washing mode and a liquid washing mode. In some embodiments, the wash apparatus 300 delivers an atomized liquid in the liquid washing mode. The wash apparatus 300 includes an inlet assembly 302 and a delivery nozzle 308 positioned downstream of the inlet assembly 302. The inlet assembly 302 includes a mixing chamber 334 that includes a porous structure 336 for in-situ foam generation when in the foam washing mode. It is contemplated that the wash apparatus 300 can be used in the wash system 100 of FIG. 1. Namely, the controller 109 of FIG. 1 can be used to operate the wash apparatus 300 and switch between the foam washing mode in which the inlet assembly 302 supplies a foam 301 to the delivery nozzle 308 and the liquid washing mode in which the inlet assembly 302 supplies a high-pressure liquid 303 to the delivery nozzle 308. Elements of the second embodiment that are similar to those in FIG. 1 have been given similar reference numbers in the three-hundred series. For example, the inlet assembly 102 described in FIG. 1 is labeled as the inlet assembly 302 in FIGS. 3A and 3B.

The inlet assembly 302 includes a first fluid conduit 304 defining a first fluid passageway 305 for delivering a gas to the delivery nozzle 308. A first valve 316A is disposed in the first fluid passageway 305 for controlling flow of the gas into the delivery nozzle 308. In some embodiments, the gas is a low-pressure gas. The inlet assembly 302 also includes a second fluid conduit 306 defining a second fluid passageway 307 for delivering a detergent to the delivery nozzle 308. A second valve 316B is disposed in the second fluid passageway 307 for controlling flow of the detergent into the delivery nozzle 308. The inlet assembly 302 also includes a third fluid conduit 321 defining a third fluid passageway 322 for delivering a liquid to the delivery nozzle 308. In some embodiments, the liquid is a high-pressure liquid. A third valve 316C is disposed in the third fluid passageway 322 for controlling flow of the liquid into the delivery nozzle 308.

In some embodiments, the controller 109 of FIG. 1 is in operative communication with the valves 316A, 316B, 316C. In this manner, the controller 109 can actuate or operate the valves 316A, 316B, 316C to switch between an open position and a closed position and also various partially open positions. In some embodiments, at least one of a pressure or a flowrate of the gas may be adjustable via the first valve 316A. A flow rate of the detergent may be adjustable via the second valve 316B. A flow rate of the liquid may be adjustable via the third valve 316C.

The inlet assembly 302 further includes a housing 360 that defines the mixing chamber 334. The mixing chamber 334 is configured to receive one or more of the gas, the detergent, and the liquid, depending on the operating mode. The housing 360 may be of any suitable shape and, in some embodiments, is generally cylindrical in shape. In the inlet assembly 302, the first fluid conduit 304, the second fluid conduit 306, and the third fluid conduit 321 are coupled to the mixing chamber 334. In this manner, the first fluid passageway 305 is in fluid communication with and delivers the gas to the mixing chamber 334. The second fluid passageway 307 is in fluid communication with and delivers the detergent to the mixing chamber 334. The third fluid passageway 322 is in fluid communication with and delivers the liquid to the mixing chamber 334. In the illustrated embodiment, the third fluid conduit 321 is positioned closer to the delivery nozzle 308 than the first fluid conduit 304 and the second fluid conduit 306. That is, the third fluid conduit 321 is coupled to the mixing chamber 334 downstream of the first fluid conduit 304 and the second fluid conduit 306.

The mixing chamber 334 includes a porous structure 336 and a check valve 362. The porous structure 336 is disposed in at least a portion of the mixing chamber 334 and is positioned or fixed upstream of the check valve 362. The third fluid conduit 321 is coupled to the mixing chamber 334 downstream of the check valve 362. The first fluid conduit 304 and the second fluid conduit 306 are coupled to the mixing chamber 334 upstream of the check valve 362. So configured, the check valve 362 may prevent the flow of the liquid into the porous structure 336 and into the first fluid conduit 304 and the second fluid conduit 306. Also, in such a configuration, the liquid delivered to the mixing chamber 334 via the third fluid conduit 321 does not pass through the porous structure 336.

In some embodiments, the controller 109 operates the valves 316A, 316B, 316C to place the wash apparatus 300 in the foam washing mode or the liquid washing mode.

In the foam washing mode (FIG. 3A), the first valve 316A and the second valve 316B are in the open position. The third valve 316C is in the closed position. So configured, gas and detergent are delivered to the mixing chamber 334. The combination of the gas and the porous structure 336 aerate the detergent to generate the foam 301.

In the liquid washing mode (FIG. 3B), the first valve 316A and the second valve 316B are in the closed position. The third valve 316C is in the open position. So configured, liquid flows into the mixing chamber 334. Because the mixing chamber 334 is downstream of the porous structure 336, the liquid does not pass through the porous structure 336 and instead flows to the delivery nozzle 308. In some embodiments, the liquid is the high-pressure liquid 303.

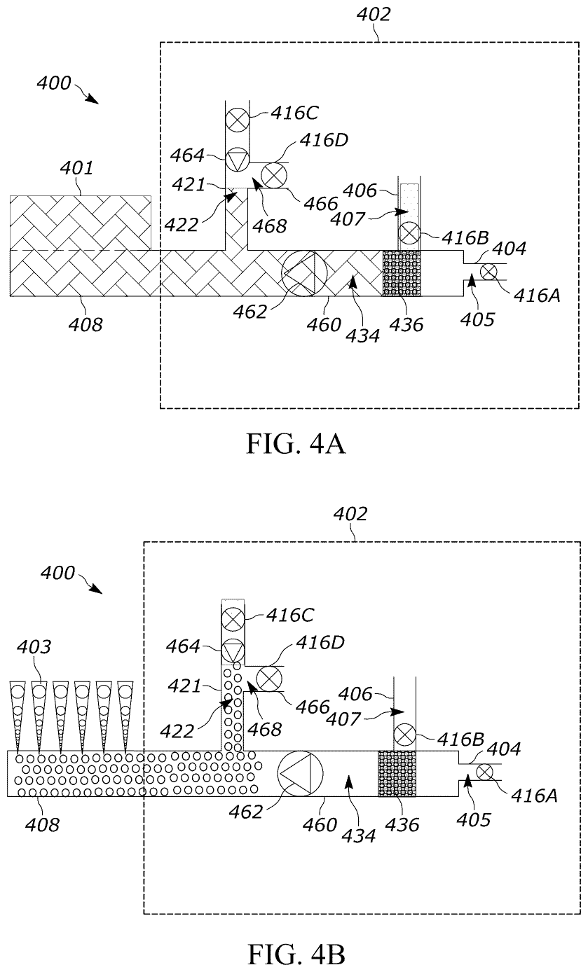

FIGS. 4A and 4B illustrate a wash apparatus 400 that can be used in the wash system 100, according to a third embodiment. The wash apparatus 400 generates foam in-situ, within an inlet assembly that is upstream of a delivery nozzle. In operation, the wash apparatus 400 may switch between a foam washing mode and a liquid washing mode. In some embodiments, the wash apparatus 400 delivers an atomized liquid in the liquid washing mode. The wash apparatus 400 includes an inlet assembly 402 and a delivery nozzle 408 positioned downstream of the inlet assembly 402. The inlet assembly 402 includes a mixing chamber 434 that includes a porous structure 436 for in-situ foam generation. It is contemplated that the wash apparatus 400 can be used in wash system 100 of FIG. 1. Namely, the controller 109 of FIG. 1 can be used to operate the wash apparatus 400 and switch between the foam washing mode in which the inlet assembly 402 supplies a foam 401 to the delivery nozzle 408 and the liquid washing mode in which the inlet assembly 402 supplies an atomized liquid 403 to the delivery nozzle 408. Elements of the third embodiment that are similar to those in FIG. 1 have been given similar reference numbers in the four-hundred series. For example, the inlet assembly 102 described in FIG. 1 is labeled as the inlet assembly 402 in FIGS. 4A and 4B.

The inlet assembly 402 includes a first fluid conduit 404 defining a first fluid passageway 405 for delivering a first gas to the delivery nozzle 408. A first valve 416A is disposed in the first fluid passageway 405 for controlling flow of the gas into the delivery nozzle 408. In some embodiments, the gas is a low-pressure gas. The inlet assembly 402 also includes a second fluid conduit 406 defining a second fluid passageway 407 for delivering a detergent to the delivery nozzle 408. A second valve 416B is disposed in the second fluid passageway 407 for controlling flow of the detergent into the delivery nozzle 408. The inlet assembly 402 also includes a third fluid conduit 421 defining a third fluid passageway 422 for delivering a liquid to the delivery nozzle 408. In some embodiments, the liquid is a high-pressure fluid. A third valve 416C is disposed in the third fluid passageway 422 for controlling flow of the liquid into the delivery nozzle 408. A second check valve 464 is disposed in the third fluid passageway 422 downstream of the third valve 416C. The inlet assembly 402 also includes a fourth fluid conduit 466 defining a fourth fluid passageway 468 for delivering a second gas to the delivery nozzle 408. In some embodiments, the second gas is a high-pressure gas. A fourth valve 416D is disposed in the fourth fluid passageway 468 for controlling flow of the second gas into the delivery nozzle 408.

In some embodiments, the controller 109 of FIG. 1 is in operative communication with the valves 416A, 416B, 416C, 416D. In this manner, the controller 109 can actuate or operate the valves 416A, 416B, 416C, 416D to switch between an open position and a closed position and also various partially open positions. In some embodiments, at least one of a pressure or a flowrate of the first gas may be adjustable via the first valve 416A. A flow rate of the detergent may be adjustable via the second valve 416B. A flow rate of the liquid may be adjustable via the third valve 416C. At least one of a pressure or a flowrate of the second gas may be adjustable via the fourth valve 416D.

The inlet assembly 402 further includes a housing 460 that defines a mixing chamber 434. The mixing chamber 434 is configured to receive one or more of the first gas, the second gas, the detergent, and the liquid, depending on the operating mode. The housing 460 may be of any suitable shape and, in some embodiments, is generally cylindrical in shape. In the inlet assembly 402, the first fluid conduit 404, the second fluid conduit 406, and the third fluid conduit 421 are coupled to the mixing chamber 434. In this manner, the first fluid passageway 405 is in fluid communication with and delivers the gas to the mixing chamber 434. The second fluid passageway 407 is in fluid communication with and delivers the detergent to the mixing chamber 434. The third fluid passageway 422 is in fluid communication with and delivers the liquid to the mixing chamber 434. In the illustrated embodiment, the third fluid conduit 421 is positioned closer to the delivery nozzle 308 than the first fluid conduit 404 and the second fluid conduit 406. That is, the third fluid conduit 421 is coupled to the mixing chamber 434 downstream of the first fluid conduit 404 and the second fluid conduit 406.

As illustrated, the fourth fluid conduit 466 is coupled to the third fluid conduit 421 upstream of the mixing chamber 434. The second check valve 464 is positioned upstream of where the fourth fluid conduit 466 ties into the third fluid conduit 421 to prevent backflow of the second gas into the liquid line.

The mixing chamber 434 includes a porous structure 436 and a first check valve 462. The porous structure 436 is disposed in at least a portion of the mixing chamber 434 and is positioned or fixed upstream of the first check valve 462. The third fluid conduit 421 is coupled to the mixing chamber 434 downstream of the first check valve 462. The first fluid conduit 404 and the second fluid conduit 406 are coupled to the mixing chamber 434 upstream of the first check valve 462. So configured, the first check valve 462 may prevent the flow of the liquid into the mixing chamber 434 and into the first fluid conduit 404 and the second fluid conduit 406. Also, in such a configuration, the liquid delivered to the mixing chamber 434 via the third fluid conduit 421 does not pass through the porous structure 436.

In some embodiments, the controller 109 operates the valves 416A, 416B, 416C, 416D to place the wash apparatus 400 in the foam washing mode or the liquid washing mode.

In the foam washing mode (FIG. 4A), the first valve 416A and the second valve 416B are in the open position. The third valve 416C and the fourth valve 416D are in the closed position. So configured, gas and detergent are delivered to the mixing chamber 434. The combination of the gas and the porous structure 436 aerate the detergent to generate the foam 401.

In the liquid washing mode (FIG. 4B), the first valve 416A and the second valve 416B are in the closed position. The third valve 416C and the fourth valve 416D are in the open position. So configured, the liquid and the second gas (e.g., a high-pressure gas) flow into the mixing chamber 434. Because the mixing chamber 434 is downstream of the porous structure 436, the liquid and the second gas do not pass through the porous structure 436 and, instead, flow to the delivery nozzle 408. It is contemplated that by introducing the second gas, in particular a high-pressure gas, into the liquid stream atomizes the liquid stream to produce the atomized liquid 403.

In some embodiments, in the liquid washing mode, pulsed liquid droplet delivery is achieved by cycling between a liquid fill phase (e.g., with the third valve 416C open and other valves closed) and a gas pulse phase (e.g., with the fourth valve 416D open and other valves closed) to accelerate and/or atomize the liquid into droplets. In some aspects, the liquid stream may be uninterrupted (e.g., with the third valve 416C open) and the fourth valve 416D cycled between the open and closed position to achieve a pulsed liquid droplet delivery.

### In-Situ Foam Generation—Within Delivery Nozzle

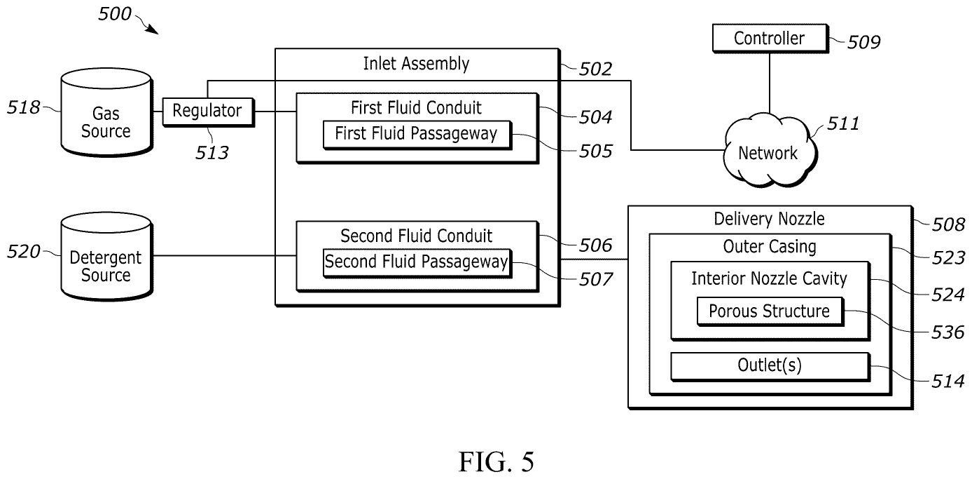

FIG. 5 illustrates a wash system 500, in accordance with some embodiments. It is generally contemplated that the wash system 500 generates a foam in-situ or within the wash system 500. Specifically, the wash system 500 generates foam within with a delivery nozzle 508. The wash system 500 can be operated to wash a variety of components such as an engine 501 or portions thereof. In some embodiments, the engine 501 is a gas turbine engine. The wash system 500 includes an inlet assembly 502 that is configured to control the delivery of a gas and a detergent to the delivery nozzle 508. The wash system 500 further includes a regulator 513 for controlling a pressure of the gas.

During a cleaning operation using the wash system 500, the delivery nozzle 508 can be inserted through one or more access ports in the engine 501. For example, the delivery nozzle 508 can be inserted through an access port that is in fluid communication with an engine core (e.g., a compressor section, combustor, and/or turbine section of the engine). In some examples, the access port can be an inlet to the core section of the engine. In other examples, the access port can be an inspection port such as a borescope inspection port(s) that may allow for inspection of the engine 501 between operations and may open into the core air flow path of the engine 501. The access port(s), for example, can be defined in the compressor section, combustor, and/or turbine section of the engine 501. The access port(s) may allow for inspection of the engine 501, for example, to allow for inspection or servicing of one or more blades, nozzles, combustion liners, and/or other components of the engine 501 between operations.

In the wash system 500, a controller 509 is in operative communication with the regulator 513 to control the pressure of the gas in the wash system 500. Further, to generate foam within the wash system 500, the delivery nozzle 508 includes an interior nozzle cavity 524 with a porous structure 536 disposed therein for aerating the detergent. The controller 509 is operable to select between a foam washing mode and a liquid washing mode for the wash system 500 by operating the regulator 513.

Turning to the various components of the wash system 500, the inlet assembly 502 includes a first fluid conduit 504. The first fluid conduit 504 defines a first fluid passageway 505 for delivering the gas to the delivery nozzle 508. The first fluid conduit 504 may be any suitable pipe, hose, tube, vessel, and so forth, which defines a fluid passageway through which a fluid may flow. The first fluid conduit 504 is in fluid communication with a gas source 518. The gas source 518 delivers any suitable gas into the first fluid conduit 504. In some forms, the gas includes at least one of air or an inert gas such as nitrogen. In some embodiments, the gas source 518 includes at least one of a gas storage tank, a plant air system, a nitrogen system, or a compressor. The regulator 513 is disposed in the first fluid passageway 505. Generally, the gas is delivered from the gas source 518 through the first fluid passageway 505 of the first fluid conduit 504 and into the delivery nozzle 508. The regulator 513 adjusts the pressure of the gas for example, to switch between delivering the gas at a high pressure for liquid washing and at a low pressure for foam washing.

The inlet assembly 502 also includes a second fluid conduit 506 defining a second fluid passageway 507 for delivering the detergent to the delivery nozzle 508. The second fluid conduit 506 may be any suitable pipe, hose, tube, vessel, and so forth, which defines a fluid passageway through which a fluid may flow. The second fluid conduit 506 is in fluid communication with a detergent source 520. The detergent source 520 delivers any suitable detergent into the second fluid conduit 506. The detergent can be any suitable detergent. The detergent can include at least one of an organic acidic component or a surfactant. The detergent can include one or more organic acidic components and/or one or more surfactants. In some embodiments, the detergent source 520 includes a detergent tank operatively coupled to a pump for delivering the detergent. In further embodiments, the detergent tank may be disposed on a mobile cart for transportation. Generally, detergent is delivered from the detergent source 520 through the second fluid passageway 507 of the second fluid conduit 506 and into the delivery nozzle 508.

As illustrated, the regulator 513 in the inlet assembly 502 is operatively coupled to the controller 509. The controller 509 is communicatively coupled to the regulator 513 over a network 511. The controller 509 is configured to switch between a foam washing mode and a liquid washing mode by operating or actuating the regulator 513. For example, the regulator 513 can be actuated between an open and closed position using the controller 509. The regulator 513, however, may be actuated by any suitable combination of manual (i.e., directly actuated by an operator) or automated (i.e., actuated by a motorized mechanism) mechanisms. In some forms, automated mechanisms may be controllable by an operator. In some embodiments, the controller 509 can adjust at least one of a pressure or a flow rate of the gas via the regulator 513.

In some embodiments, one or more of the sources 518, 520 may provide a constant or approximately constant fluid flow into a conduit requiring a valve to control the flow of fluid out of the conduit. In some embodiments, a fluid source may be controllable such that a fluid flow into a conduit is non-constant and the fluid flow out of the conduit is controllable directly from the fluid source. In such an embodiment, a conduit may not include a valve within a respective passageway to control the flow of a fluid into the delivery nozzle 508.

The delivery nozzle 508 is in fluid communication with the inlet assembly 502. The delivery nozzle 508 includes an outer casing 523 that defines an interior nozzle cavity 524. The outer casing 523 also defines at least one outlet opening 514. The outlet openings 514 are configured to output any combination of the fluids from sources 518, 520 from the delivery nozzle 508. The outlet openings 514 may have any suitable number, shape, spacing, and/or configuration. In some embodiments, the outlet openings 514 may be in the form of multiple uniformly spaced and/or uniformly sized outlet openings 514, while in some embodiments the outlet openings 514 may not be uniformly spaced and/or sized. It is generally contemplated that any side and/or surface of the delivery nozzle 508 may include the at least one outlet opening 514 such that the fluid output from the delivery nozzle 508 is output from the wash system 500. Generally, the fluid output from the wash system 500 via the at least one outlet opening 514 is directed to aircraft components, such as internal structures of a gas turbine engine, for cleaning of the components.

The interior nozzle cavity 524 includes the porous structure 536 for foam generation. The porous structure 536 aids foam generation by aerating the detergent in the foam washing mode. In particular, the porous structure 536 and the interior nozzle cavity 524 may be configured to generate the foamed cleaning fluid in the foam washing mode. Further, the porous structure 536 may aid in aerating or, in some aspects, atomizing the liquid in the liquid washing mode.

In operation, the regulator 513 is configured to control the flow of the gas to the delivery nozzle 508. The controller 509 operates or actuates the regulator 513 to select between the foam washing mode and the liquid washing mode. In the foam washing mode the delivery nozzle 508 delivers a foam for cleaning. To deliver a foam in the foam washing mode, the regulator 513 is actuated to deliver the gas at a low pressure. When the regulator 513 is so configured, the gas flows through the first fluid passageway 505 at a low pressure and the detergent flows through the second fluid passageway 507. The low-pressure gas and detergent are mixed and/or aerated in the interior nozzle cavity 524 to generate the foam. The foam is delivered from the interior nozzle cavity 524 through the at least one outlet opening 514. In the liquid washing mode, the regulator 513 is actuated to deliver the gas at a high pressure. When the regulator is so configured, the detergent flows through the second fluid passageway 507 and passes through the inlet assembly 502 to the delivery nozzle 508. The high-pressure gas facilitates droplet formation in the liquid stream. Generally, the liquid is in the form of an erosive stream which hits the component of the gas turbine engine being washed (e.g., a high-pressure compressor blade).

In some embodiments, in the foam washing mode, the controller 109 can change the type or properties of the foam generated, for example, by varying flow rate of the gas in the first fluid passageway 105 by adjusting the first valve 116A and by varying flow rate of the detergent in the second fluid passageway 107 by adjusting the second valve 116B. In some embodiments, in the liquid washing mode, the liquid has a pressure greater than 1500 psi. In some embodiments, in the liquid washing mode, the liquid has a droplet size of greater than 30 microns.

In some embodiments, the controller 509 may be pre-programmed to operate the wash system 500 in the foam washing mode and/or the liquid washing mode for a pre-determined amount of time. For example, the controller 509 may operate the wash system 500 in the foam washing mode for a set amount of time before switching to the liquid washing mode. In addition, the controller 509 may be pre-programmed to carry out any number (e.g., a predetermined number) of foam washing and/or liquid washing cycles.

In some embodiments, a flow rate of the detergent in the foam washing mode is in the range of about 0.01 gallons per minute to 0.08 gallons per minute, and a flow rate of the detergent in the liquid washing mode is in a range of about 0.5 gallons per minute to 7 gallons per minute. While the ranges provided are preferred ranges, it is generally understood that any alternate range of foam flow rate and/or liquid flow rate may be used as suitable for a specified application.

Subsequent figures illustrate various configurations of wash assemblies that can be used in conjunction with the wash system 500. The wash assemblies are configured for in-situ foam generation within the delivery nozzle 508.

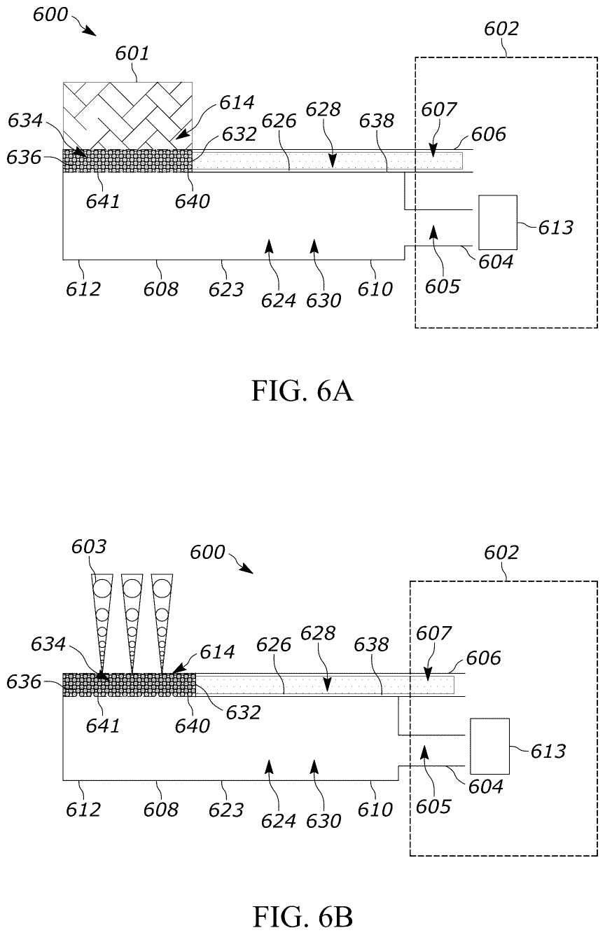

FIGS. 6A and 6B illustrate a wash apparatus 600 for in-situ foam generation within a delivery nozzle that can be used in the wash system 500, according to a first embodiment. In operation, the wash apparatus 600 may switch between a foam washing mode and a liquid washing mode. In some embodiments, the wash apparatus 600 delivers an atomized liquid in the liquid washing mode. The wash apparatus 600 includes an inlet assembly 602 and a delivery nozzle 608. The delivery nozzle 608 includes a mixing chamber 634 at a feed end 610 of the delivery nozzle 608, with a porous structure 636 disposed in the mixing chamber 634 for generating a foam 601. It is contemplated that the wash apparatus 600 can be used in the wash system 500 of FIG. 5. Namely, the controller 509 of FIG. 5 can be used to operate the wash apparatus 600 in a foam washing mode and a liquid washing mode. In the foam washing mode (FIG. 6A), the foam 601 is generated within the delivery nozzle 608 via the porous structure 636. Elements of the first embodiment that are similar to those in FIG. 5 have been given similar reference numbers in the six-hundred series. For example, the inlet assembly 502 described in FIG. 5 is labeled as the inlet assembly 602 in FIGS. 6A and 6B.

The inlet assembly 602 includes a first fluid conduit 604 defining a first fluid passageway 605 for delivering a gas to the delivery nozzle 608. A regulator 613 is disposed in the first fluid passageway 605 for regulating the pressure of the gas. In some embodiments, the controller 509 is in operative communication with the regulator 613. The inlet assembly 602 further includes a second fluid conduit 606 defining a second fluid passageway 607 for delivering a detergent to the delivery nozzle 608.

The delivery nozzle 608 includes a feed end 610 and a delivery end 612. The delivery nozzle 608 is elongated along a longitudinal axis that runs from the feed end 610 to the delivery end 612. The feed end 610 of the delivery nozzle 608 is coupled to the inlet assembly 602, and the delivery end 612 includes at least one outlet opening 614. While three outlet openings 614 are illustrated, it is generally understood that any alternate suitable number of outlet openings 614 may be used.

The delivery nozzle 608 also includes an outer casing 623, a first inner wall 626, and a second inner wall 632. The outer casing 623 encloses an interior nozzle cavity 624 of the delivery nozzle 608. In some embodiments, the outer casing 623 has a cylindrical shape that is closed at the delivery end 612 and that is open at the feed end 610. In some forms, the outer casing 623 may include any suitable material, thickness, and/or dimensions. The outer casing 623 may further include the at least one outlet opening 614. The delivery nozzle 608 defines an axial direction that extends parallel to a longitudinal axis of the delivery nozzle 208, a radial direction, and a circumferential direction extending about the axial direction. In some embodiments, the at least one outlet opening 614 is in the form of a plurality of outlet openings 614 which are linearly aligned on the delivery nozzle 608 along the axial direction.

The interior nozzle cavity 624 is defined or bounded by the outer casing 623 and may have any suitable dimensions and/or configuration. In some forms, the shape of the interior nozzle cavity 624 may be similar to or the same as the shape of the outer casing 623 (e.g., the outer casing 623 and the interior nozzle cavity 624 each have a cylindrical shape). In some embodiments, at least a portion of the shape of the interior nozzle cavity 624 may be different than the shape of the outer casing 623 (e.g., the shape of the outer casing 623 is cylindrical and the shape of the interior nozzle cavity 624 is conical) due to non-uniform thickness of the outer casing 623.

The first inner wall 626 is disposed within the interior nozzle cavity 624 such that the first inner wall 626 divides the interior nozzle cavity 624 into a first chamber 628 and a second chamber 630. In some embodiments, the first inner wall 626 extends at least a portion of the length of the delivery nozzle 608 along the longitudinal axis. The first chamber 628 is in fluid communication with the first fluid conduit 604, and the second chamber 630 is in fluid communication with the second fluid conduit 606. While the described embodiment includes two chambers 628, 630, it is generally contemplated that any alternate suitable number of chambers may be used. As illustrated, the wash apparatus 600 includes two conduits 604, 606 and two respective chambers 628, 630, in some embodiments there may be any alternate suitable number of conduits, and each conduit may be in fluid communication with a respective chamber.

The first inner wall 626 of the delivery nozzle 608 extends through the interior nozzle cavity 624 along the axial direction. In the described embodiment, the mixing chamber 634 is disposed at the delivery end 612 of the delivery nozzle 608. In some embodiments, the first inner wall 626 has a proximal end 638 adjacent to the inlet assembly 602 and a distal end 640 opposite the proximal end 638. The distal end 640 of the first inner wall 626 has a plurality of holes 641 of any suitable shape, number, size, and/or configuration in fluid communication with the mixing chamber 634. In some embodiments, the second inner wall 632 may further and/or alternately include the plurality of holes 641.

The second inner wall 632 is disposed in the interior nozzle cavity 624 such that the second inner wall 632 defines at least a portion of a mixing chamber 634. In some embodiments, the second inner wall 632 of the delivery nozzle 608 extends radially across the second inner wall 632 from the first inner wall 626 to the outer casing 623 of the delivery nozzle 608. In the described embodiment, the mixing chamber 634 is in fluid communication with the first chamber 628, the second chamber 630, and the at least one outlet opening 614. In some forms, the mixing chamber 634 may include the outlet openings 614, while in some aspects the mixing chamber 634 may be in fluid communication with the at least one outlet opening 614 via an additional portion of the interior nozzle cavity 624.

A porous structure 636 is disposed within the mixing chamber 634. The porous structure 636 helps to generate the foam 601 in the foam washing mode and a liquid detergent in the liquid washing mode. In some embodiments, the porous structure 636 is a mesh material.

FIG. 6A illustrates the wash apparatus 600 in the foam washing mode. In the foam washing mode, the controller 509 sets the regulator 613 to a low pressure and the low-pressure gas is fed to the delivery nozzle 608 via the first fluid passageway 605. The liquid detergent is fed to the delivery nozzle 608 via the second fluid passageway 607 concurrently with the low-pressure gas. The low-pressure gas and the detergent enter the delivery nozzle 608 at the feed end 610 and flow into the mixing chamber 634. The porous structure 636 in the mixing chamber 634 and the low-pressure gas aerate the detergent to generate the foam 601. The foam 601 is delivered to a target surface via the outlet openings 614.

FIG. 6B illustrates the wash apparatus 600 in the liquid washing mode. In the liquid washing mode, the controller 509 sets the regulator 613 to a high pressure to deliver high-pressure gas to the delivery nozzle 608 via the first fluid passageway 605. The liquid detergent is fed to the delivery nozzle 608 via the second fluid passageway 607 concurrently with the high-pressure gas. The high-pressure gas and the detergent enter the delivery nozzle 608 at the feed end 610 and flow into the mixing chamber 634. The porous structure 636 in the mixing chamber 634 and the high-pressure gas may atomize the detergent to generate a liquid detergent 603. The liquid detergent 603 is delivered to a target surface via the outlet openings 614. It is contemplated that exposing the liquid to the high-pressure liquid in the porous structure 636 may facilitate atomization of the detergent such that the liquid detergent 603 is an atomized liquid detergent.

In some embodiments, in the liquid washing mode, pulsed liquid droplet delivery is achieved by cycling between a liquid fill phase where liquid detergent is delivered to the delivery nozzle 608 via the second fluid passageway 607 and a pulse of high-pressure gas is delivered to the delivery nozzle 608 via the first fluid passageway 605 to accelerate and/or atomize the liquid detergent into droplets.

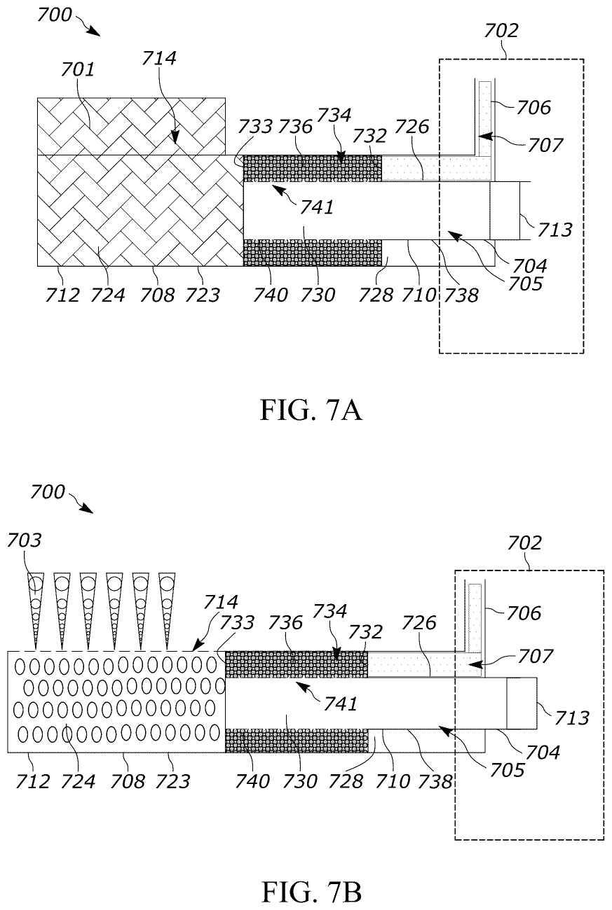

FIGS. 7A and 7B illustrate a wash apparatus 700 for in-situ foam generation within a delivery nozzle that can be used in the wash system 500, according to a second embodiment. In operation, the wash apparatus 700 may switch between a foam washing mode and a liquid washing mode. In some embodiments, the wash apparatus 700 delivers an atomized liquid in the liquid washing mode. The wash apparatus 700 includes an inlet assembly 702 and delivery nozzle 708. The delivery nozzle 708 includes a mixing chamber 734 disposed at a feed end 710 of the delivery nozzle 708 with a porous structure 736 disposed in the mixing chamber 734 for generating a foam 701. It is contemplated that the wash apparatus 700 can be used in the wash system 500 of FIG. 5. Namely, the controller 509 of FIG. 5 can be used to operate the wash apparatus 700 in a foam washing and a liquid washing mode. In the liquid washing mode, the foam 701 is generated within the delivery nozzle 708 via the porous structure 736. Elements of the second embodiment that are similar to those in FIG. 5 have been given similar reference numbers in the seven-hundred series. For example, the inlet assembly 502 described in FIG. 5 is labeled as the inlet assembly 702 in FIGS. 7A and 7B.

The inlet assembly 702 includes a first fluid conduit 704 defining a first fluid passageway 705 for delivering a gas to the delivery nozzle 708. A regulator 713 is disposed in the first fluid passageway 705 for regulating the pressure of the gas. In some embodiments, the controller 509 is in operative communication with the regulator 713. The inlet assembly 702 further includes a second fluid conduit 706 defining a second fluid passageway 707 for delivering a detergent to the delivery nozzle 708.

The delivery nozzle 708 includes a feed end 710 and a delivery end 712. The delivery nozzle 708 is elongated along a longitudinal axis that runs from the feed end 710 to the delivery end 712. The feed end 710 of the delivery nozzle 708 is coupled to the inlet assembly 702, and the delivery end 712 includes at least one outlet opening 714. While six outlet openings 714 are illustrated, it is generally understood that any alternate suitable number of outlet openings 714 may be used.

The delivery nozzle 708 also includes an outer casing 723, a first inner wall 726, a second inner wall 732, and a third inner wall 733. The outer casing 723 encloses an interior nozzle cavity 724 of the delivery nozzle 708. In some embodiments, the outer casing 723 has a cylindrical shape that is closed at the delivery end 712 and that is open at the feed end 710. In some forms, the outer casing 723 may include any suitable material, thickness, and/or dimensions. The outer casing 723 may further include the at least one outlet opening 714. The delivery nozzle 708 defines an axial direction that extends parallel to a longitudinal axis of the delivery nozzle, a radial direction, and a circumferential direction extending about the axial direction. In some embodiments, the at least one outlet opening 714 is in the form of a plurality of outlet openings 714 which are linearly aligned on the delivery nozzle 708 along the axial direction. In some embodiments, the outer casing 723 of the delivery nozzle 708 has a cylindrical shape that is closed at the delivery end 712 and that has one or more inlet openings at the feed end 710.

The interior nozzle cavity 724 is defined or bounded by the outer casing 723 and may have any suitable dimensions and/or configuration. In some forms, the shape of the interior nozzle cavity 724 may be similar to or the same as the shape of the outer casing 723 (e.g., the outer casing 723 and the interior nozzle cavity 724 each have a cylindrical shape). In some embodiments, at least a portion of the shape of the interior nozzle cavity 724 may be different than the shape of the outer casing 723 (e.g., the shape of the outer casing 723 is cylindrical and the shape of the interior nozzle cavity 24 is conical) due to non-uniform thickness of the outer casing 723.

The first inner wall 726 is disposed within the interior nozzle cavity 724 such that the first inner wall 726 divides the interior nozzle cavity 724 into a first chamber 728 and a second chamber 730. In some embodiments, the first inner wall 726 extends at least a portion of the length of the delivery nozzle 708 along the longitudinal axis. The first chamber 728 is in fluid communication with the first fluid conduit 704, and the second chamber 730 is in fluid communication with the second fluid conduit 706. While the described embodiment includes two chambers 728, 730, it is generally contemplated that any alternate suitable number of chambers may be used. As illustrated, the wash apparatus 700 includes two conduits 704, 706 and two respective chambers 728, 730, in some embodiments there may be any alternate suitable number of conduits, and each conduit may be in fluid communication with a respective chamber.

The first inner wall 726 of the delivery nozzle 708 extends through the interior nozzle cavity 724 along the axial direction. In the described embodiment, the mixing chamber 734 is disposed at or adjacent to the feed end 710 of the delivery nozzle 708. In some embodiments, the first inner wall 726 has a proximal end 738 adjacent to the inlet assembly 702 and a distal end 740 opposite the proximal end 738. The distal end 740 of the first inner wall 726 has a plurality of holes 741 of any suitable shape, number, size, and/or configuration in fluid communication with the mixing chamber 734. In some embodiments, the second inner wall 732 and the third inner wall 733 may further and/or alternately include the plurality of holes 741. As illustrated, the first inner wall 726 is an annular wall that extends axially through the interior nozzle cavity 724 and is spaced from the outer casing 723 of the delivery nozzle 708. In some examples, the annular first inner wall 726 is concentric to the outer casing 723. The first inner wall 726 does not extend an entire length of the delivery nozzle 708. As illustrated, the first inner wall 726 does not extend to the delivery end 712 of the delivery nozzle 708 and instead, terminates between the feed end 710 and the delivery end 712 of the delivery nozzle 708.

The second inner wall 732 is disposed in the interior nozzle cavity 724 such that the second inner wall 732 defines at least a portion of the mixing chamber 734. In some embodiments, the second inner wall 732 of the delivery nozzle 708 extends radially across the second inner wall 732 from the first inner wall 726 to the outer casing 723 of the delivery nozzle 708.

A first space between the first inner wall 726 and the outer casing 723 defines the first chamber 728. A second space within an interior of the first inner wall 726 defines the second chamber 730. In some examples, the first space is an annular region. The second space is cylindrical in shape. It is generally contemplated that any suitable shape may be used such that the outer casing 723 and the annular first inner wall 726 are concentric.

The third inner wall 733 is also disposed within the interior nozzle cavity 724. The third inner wall 733 is spaced from the second inner wall 732 and defines the mixing chamber 734 therebetween. The second inner wall 732 and the third inner wall 733 extend radially across the delivery nozzle 708 from the first inner wall 726 to the outer casing 723.

In the described embodiment, the mixing chamber 734 is spaced from the distal end of the delivery nozzle 708. In other words, there is a portion of the interior nozzle cavity 724 disposed downstream of the mixing chamber 734. Though, as illustrated, the mixing chamber 734 is disposed about a portion of the annular first inner wall 726, in some embodiments the mixing chamber 734 may be disposed at least partially below the annular first inner wall 726. The mixing chamber 734 is in fluid communication with the first chamber 728, the second chamber 730, and the at least one outlet opening 714. In some forms, the mixing chamber 734 may include the outlet openings 714, while in some aspects, the mixing chamber 734 may be in fluid communication with the at least one outlet opening 714 via an additional portion of the interior nozzle cavity 724.

A porous structure 736 is disposed within the mixing chamber 734. The porous structure 736 helps to generate the foam 701 in the foam washing mode and a liquid detergent 703 in the liquid washing mode. In some embodiments, the porous structure 736 is a mesh material.

FIG. 7A illustrates the wash apparatus 700 in the foam washing mode. In the foam washing mode, the controller 509 sets the regulator 713 to a low pressure and the low-pressure gas is fed to the delivery nozzle 708 via the first fluid passageway 705. The liquid detergent is fed to the delivery nozzle 708 via the second fluid passageway 707 concurrently with the low-pressure gas. The low-pressure gas and the detergent enter the delivery nozzle 708 at the feed end 710 and flow into the mixing chamber 734. The porous structure 736 in the mixing chamber 734 and the low-pressure gas aerate the detergent to generate the foam 701. The foam 701 is delivered to the delivery end 712 of the delivery nozzle 708 and passes through the outlet openings 714.

FIG. 7B illustrates the wash apparatus 700 in the liquid washing mode. In the liquid washing mode, the controller 509 sets the regulator 713 to a high pressure to deliver high-pressure gas to the delivery nozzle 708 via the first fluid passageway 705. The liquid detergent is fed to the delivery nozzle 708 via the second fluid passageway 707 concurrently with the high-pressure gas. The high-pressure gas and the detergent enter the delivery nozzle 708 at the feed end 710 and flow into the mixing chamber 734. The porous structure 736 in the mixing chamber 734 and the high-pressure gas may atomize the detergent to generate a liquid detergent 703. The liquid detergent is delivered to a target surface via the outlet openings 714. It is contemplated that exposing the liquid to the high-pressure liquid in the porous structure 736 may facilitate atomization of the detergent such that the liquid detergent 703 is an atomized liquid detergent.

In some embodiments, in the liquid washing mode, pulsed liquid droplet delivery is achieved by cycling between a liquid fill phase where liquid detergent is delivered to the delivery nozzle 708 via the second fluid passageway 707 and a pulse phase where a pulse of high-pressure gas is delivered to the delivery nozzle 708 via the first fluid passageway 705 to accelerate and/or atomize the liquid detergent into droplets.

### Foam Ingestion

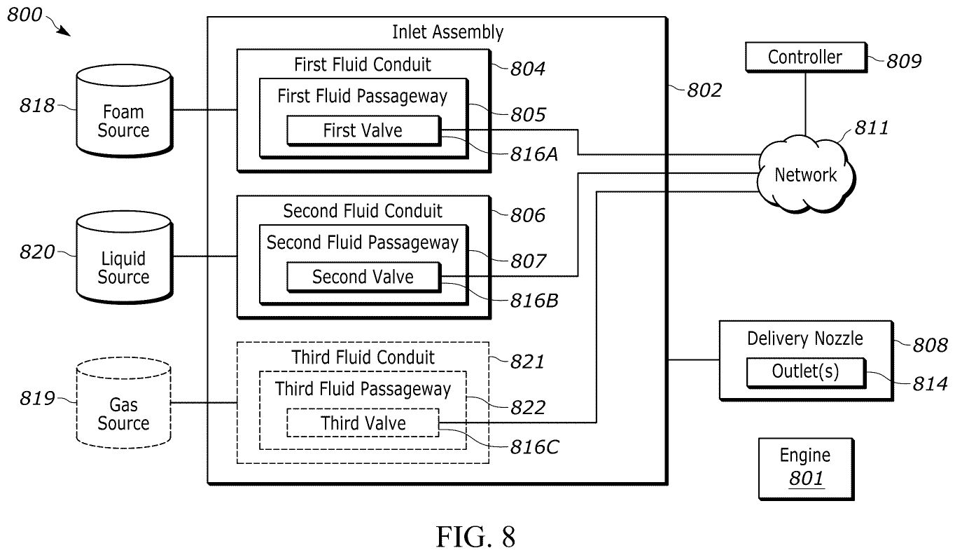

Turning now to FIG. 8, a wash system 800 is illustrated. It is generally contemplated that the wash system 800 ingests foam from a foam source that is outside of or external to the wash system 800. While the wash system 100 (FIG. 1) and the wash system 500 (FIG. 5) include devices such as porous structures that are capable of generating foam, the wash system 800 lacks a foam generating device within the system and, instead, receives or ingests pre-generated foam from a foam source (e.g., foam source 818). The wash system 800 can be operated in at least two different modes: a foam washing mode, and a liquid washing mode. In the foam washing mode, the wash system 800 ingests foam and delivers foam through the delivery nozzle 808. In the liquid washing mode, the wash system 800 ingests a liquid and, in some embodiments, a gas to generate a high-pressure liquid. In some embodiments, the wash system 800 delivers a high-pressure liquid in the liquid washing mode. In other embodiments, the wash system 800 delivers an atomized liquid in the liquid washing mode. The wash system 800 can be used to clean a gas turbine engine (not shown) or portions thereof.

Specifically, the wash system 800 includes an inlet assembly 802 coupled to a delivery nozzle 808. The inlet assembly 802 is configured to control the delivery of a foam (e.g., a pre-generated foam), a liquid, and a gas to the delivery nozzle 808. The wash system 800 further includes a plurality of valves including a first valve 816A, a second valve 816B, and, in some embodiments, a third valve 816C. The first valve 816A controls the flow of foam to the delivery nozzle 808. The second valve 816B controls the flow of the liquid to the delivery nozzle 808. The third valve 816C controls the flow of the gas to the delivery nozzle 808. Together, the first valve 816A, the second valve 816B, and the third valve 816C may also be referred to herein as a “valve system.”

During a cleaning operation using the wash system 800, the delivery nozzle 808 can be inserted through one or more access ports in the gas turbine engine (not shown). For example, the delivery nozzle 808 can be inserted through an access port that is in fluid communication with an engine core (e.g., a compressor section, combustor, and/or turbine section of the engine). In some examples, the access port can be an inlet to the core section of the engine. In other examples, the access port can be an inspection port such as a borescope inspection port(s) that may allow for inspection of the engine between operations and may open into the core air flow path of the engine. The access port(s), for example, can be defined in the compressor section, combustor, and/or turbine section of the gas turbine engine. The access port(s) may allow for inspection of the engine, for example, to allow for inspection or servicing of one or more blades, nozzles, combustion liners, and/or other components of the engine 801 between operations.

In the wash system 800, a controller 809 is in operative communication with the plurality of valves 816A, 816B, 816C to control the flow of the foam, the liquid, and the gas in the wash system 800. In some embodiments, the controller 809 is operable to select between the foam washing mode and the liquid washing mode for the wash system 800 by operating the plurality of valves 816A, 816B, 816C.

Turning to the various components of the wash system 800, the inlet assembly 802 includes a first fluid conduit 804. The first fluid conduit 804 defines a first fluid passageway 805 for delivering the foam to the delivery nozzle 808. The first fluid conduit 804 may be any suitable pipe, hose, tube, vessel, and so forth, which defines a fluid passageway through which a fluid may flow. The first fluid conduit 804 is in fluid communication with a foam source 818. The foam source 818 delivers a pre-generated foam into the first fluid conduit 804. In some embodiments, the foam source 818 includes a foam generation and delivery device, such as a pump. The foam source 818 may also include one or more foam generation devices configured to aerate a detergent to generate the foam. In further embodiments, one or more of the foam generation and the delivery device may be disposed on a mobile cart for transportation. The first valve 816A is disposed in the first fluid passageway 805. Generally, the foam is delivered from the foam source 818 through the first fluid passageway 805 of the first fluid conduit 804 and into the delivery nozzle 808 when the first valve 816A is in an open state.

The inlet assembly 802 also includes a second fluid conduit 806 defining a second fluid passageway 807 for delivering the liquid to the delivery nozzle 808. The second fluid conduit 806 may be any suitable pipe, hose, tube, vessel, and so forth, which defines a fluid passageway through which a fluid may flow. The second fluid conduit 806 is in fluid communication with a liquid source 820. The liquid source 820 delivers any suitable liquid into the second fluid conduit 806. The liquid can be any suitable liquid. In some forms, the liquid is water or a hydrocarbon solvent. In some embodiments, the liquid source 820 includes a liquid tank operatively coupled to a pump for delivering the liquid. In further embodiments, the liquid tank may be disposed on a mobile cart for transportation. The second valve 816B is disposed in the second fluid passageway 807. Generally, liquid is delivered from the liquid source 820 through the second fluid passageway 807 of the second fluid conduit 806 and into the delivery nozzle 808 when the second valve 816B is in an open state.

In some embodiments, the inlet assembly 802 may also include a third fluid conduit 821. The third fluid conduit 821 defines a third fluid passageway 822 for delivering a gas to the delivery nozzle 808. The third fluid conduit 821 may be any suitable pipe, hose, tube, vessel, and so forth, which defines a fluid passageway through which a fluid may flow. The third fluid conduit 821 is in fluid communication with a gas source 819. In some embodiments, the gas source 819 includes at least one of a gas storage tank, a plant air system, a nitrogen system, or a compressor. The third valve 816C is disposed in the third fluid passageway 822. Generally, the gas is delivered from the gas source 819 through the third fluid passageway 822 of the third fluid conduit 821 and into the delivery nozzle 808 when the third valve 816C is in an open state.

As illustrated, the plurality of valves 816A, 816B, 816C in the inlet assembly 802 are operatively coupled to the controller 809. The controller 809 is communicatively coupled to the valve system over a network 811. The controller 809 is configured to switch between a foam washing mode and a liquid washing mode by operating or actuating the plurality of valves 816A, 816B, 816C. Each of the plurality of valves 816A, 816B, 816C can be actuated between an open and a closed position using the controller 809. The plurality of valves 816A, 816B, 816C, however, may be actuated by any suitable combination of manual (i.e., directly actuated by an operator) or automated (i.e., actuated by a motorized mechanism) mechanisms. In some forms, automated mechanisms may be controllable by an operator. In some embodiments, the controller 809 can adjust a flow rate of the foam via the first valve 816A. In some embodiments, the controller 809 can adjust a flow rate of the liquid via the second valve 816B. In some embodiments, the controller 809 can adjust at least one of a pressure or a flow rate of the gas via the third valve 816C.

In some embodiments, one of the sources 818, 819, 820 may provide a constant fluid flow into a conduit requiring a valve to control the flow of fluid out of the conduit. In some embodiments, a fluid source may be controllable such that a fluid flow into a conduit is non-constant and the fluid flow out of the conduit is controllable directly from the fluid source. In such an embodiment, a conduit may not include a valve within a respective passageway to control the flow of a fluid into the delivery nozzle 108.

The delivery nozzle 808 is in fluid communication with the inlet assembly 802. The delivery nozzle 808 includes at least one outlet opening 814. The outlet openings 814 are configured to output any combination of the fluids from sources 818, 819, 820 from the delivery nozzle 808. The outlet openings 814 may have any suitable number, shape, spacing, and/or configuration. In some embodiments, the outlet openings 814 may be in the form of multiple uniformly spaced and/or uniformly sized outlet openings 814, while in some embodiments the outlet openings 814 may not be uniformly spaced and/or sized. It is generally contemplated that any side and/or surface of the delivery nozzle 808 may include the at least one outlet opening 814 such that the fluid output from the delivery nozzle 808 is output from the wash system 800. Generally, the fluid output from the wash system 800 via the at least one outlet opening 814 is directed to aircraft components, such as internal structures of a gas turbine engine, for cleaning of the components.

In operation, the plurality of valves 816A, 816B, 816C are configured to control the flow of the foam, the liquid, and the gas into the delivery nozzle 808. The controller 809 operates or actuates the plurality of valves 816A, 816B, 816C to select between the foam washing mode and the liquid washing mode. In the foam washing mode the inlet assembly 802 ingests a foam for cleaning. In the foam washing mode, the first valve 816A is in the open position and the second valve 816B and the third valve 816C are in the closed position. When the valves are so configured, the foam flows through the first fluid passageway 805 and is delivered through the delivery nozzle 808. In the liquid washing mode, the first valve 816A is in the closed position and the second valve 816 is in the open position to deliver the liquid to the delivery nozzle 808. In some embodiments, the liquid is a high-pressure liquid such that the liquid washing mode facilitates pressure washing. In some embodiments, in the liquid washing mode, the third valve 816C may be in the closed position so that gas is not supplied to the delivery nozzle 808. In other embodiments, in the liquid washing mode, the third valve 816C is in the open position to supply the gas to the delivery nozzle 808. When the third valve 816C is open in the liquid washing mode, the gas (e.g., a high-pressure gas) can be used to atomize the liquid to generate liquid droplets to use in cleaning. Generally, the liquid is in the form of an erosive stream which hits the component of the gas turbine engine being washed (e.g., a high-pressure compressor blade). In some embodiments, in the liquid washing mode, the liquid has a pressure greater than 1500 psi. In some embodiments, in the liquid washing mode, the liquid has a droplet size of greater than 30 microns.

In some embodiments, the controller 809 may be pre-programmed to operate the wash system 800 in the foam washing mode and/or the liquid washing mode for a pre-determined amount of time. For example, the controller 809 may operate the wash system 800 in the foam washing mode for a set amount of time before switching to the liquid washing mode. In addition, the controller 809 may be pre-programmed to carry out any number (e.g., a predetermined number) of foam washing and/or liquid washing cycles.

In some embodiments, a flow rate of the foam in the foam washing mode is in the range of about 0.04 gallons per minute to about 4.0 gallons per minute, and a flow rate of the liquid in the liquid washing mode is in a range of about 0.5 gallons per minute to 7 gallons per minute. While the ranges provided are preferred ranges, it is generally understood that any alternate range of foam flow rate and/or liquid flow rate may be used as suitable for a specified application.

Subsequent figures illustrate various configurations of wash assemblies that can be used in conjunction with the wash system 800. The wash assemblies are configured to ingest foam from an external source, that is, a source that is outside of the wash system 800.

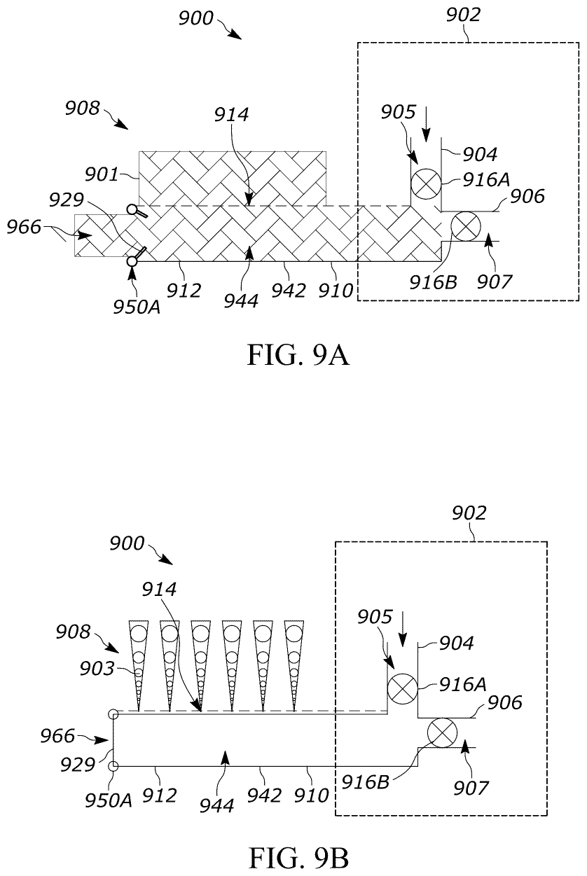

FIGS. 9A and 9B illustrate a wash apparatus 900 that ingests foam from an external source and can be used with the wash system 800, according to a first embodiment. The wash apparatus 900 can deliver foam from an external source (e.g., a source that is external to the wash system 800). The wash system 800 lacks a porous structure or other device for internal foam generation. The wash apparatus 900 includes an inlet assembly 902 and delivery nozzle 908. The inlet assembly 902 is operable to switch between a foam washing mode and a liquid washing mode. In some embodiments, the wash apparatus 900 delivers a pressurized liquid (e.g., a high-pressure liquid) in the liquid washing mode. In the foam washing mode (FIG. 9A), the inlet assembly 902 ingests foam from an external foam source (not shown) and supplies the foam 901 to the delivery nozzle 908. In the liquid washing mode (FIG. 9B), the inlet assembly 902 receives a liquid 903 and supplies the liquid 903 to the delivery nozzle 908. It is contemplated that the wash apparatus 900 can be used in the wash system 800 of FIG. 8. Namely, the controller 809 of FIG. 8 can be used to operate the wash apparatus 900 in the foam washing mode and the liquid washing mode. Elements of the first embodiment that are similar to those in FIG. 8 have been given similar reference numbers in the nine-hundred series. For example, the inlet assembly 802 described in FIG. 8 is labeled as the inlet assembly 902 in FIGS. 9A and 9B.

The inlet assembly 902 includes a first fluid conduit 904 defining a first fluid passageway 905 for delivering the foam 901 to the delivery nozzle 908. A first valve 916A is disposed in the first fluid passageway 905 for controlling flow of the foam 901 to the delivery nozzle 908. The inlet assembly 902 also includes a second fluid conduit 906 defining a second fluid passageway 907 for delivering the liquid 903 to the delivery nozzle 908. In some embodiments, the liquid 903 is water. In some embodiments, the liquid 903 is a high-pressure liquid. A second valve 916B is disposed in the second fluid passageway 907 for controlling flow of the liquid 903 to the delivery nozzle 908. In some embodiments, the controller 809 is in operative communication with the first valve 916A and the second valve 916B.

The delivery nozzle 908 includes a feed end 910 and a delivery end 912. The feed end 910 of the delivery nozzle 908 is coupled to the inlet assembly 902. The delivery nozzle 908 includes an outer casing 942, a foam washing flap 929, at least one outlet opening 914, and a foam opening 966.

The outer casing 942 encloses an interior nozzle cavity 944. In some embodiments, the outer casing 942 is generally cylindrical in shape. The outer casing 942 defines at least one of the outlet openings 914 and the foam opening 966. A total area of the foam opening 966 is larger than a total area of the outlet openings 914. The outer casing 942 may include any suitable number, size, shape, and/or configuration of foam openings 966. In some embodiments, the foam opening 966 is disposed at the delivery end 912 of the delivery nozzle 908. The outer casing 942 may include any suitable number, size, shape, and/or configuration of the outlet openings 914. In some embodiments, the outlet openings 914 are disposed on a side of the delivery nozzle 908. In some embodiments, the outer casing 942 defines an axial direction that extends from the feed end 910 to the delivery end 912 of the delivery nozzle 908 and a radial direction that extends perpendicular to the axial direction. The outlet openings 914 may be disposed on the outer casing 942 along the axial direction and, in some configurations the outlet openings 914 are linearly aligned along the axial direction. While the embodiment shown in FIGS. 9A and 9B includes a plurality of outlet openings 914 and one foam opening 966 on the delivery end 912 of the delivery nozzle 908, it is generally contemplated that any alternate suitable number and/or configuration of openings may be used.

The foam washing flap 929 is coupled to the outer casing 942 adjacent to the foam opening 966 by a spring 950A. The foam washing flap 929 is movable between a closed position in which the foam washing flap 929 seals the foam opening 966, and an open position in which the foam washing flap 929 is spaced from the foam opening 966. In some aspects, the spring 950A is designed such that the foam washing flap is in a fully closed position when a pressure in the interior nozzle cavity is in the range of 5 psi to 500 psi. In some aspects, the spring 950A exerts a force sufficient to bias the foam washing flap 929 in a closed position when the first fluid conduit 904 delivers the foam 901 to the interior nozzle cavity 944. In some embodiments, the spring 950A is a torsion spring, though, it is also contemplated that any suitable biasing element can be employed. The spring 950A may be any suitable torsion springs such as single coil, double coil, helical, and so forth.

In some embodiments, a ratio of a total surface area of the foam opening 966 to a total surface area of the outlet openings 914 is in the range of about 6:1 and about 10:1.

FIG. 9A illustrates the wash apparatus 900 in the foam washing mode. In the foam washing mode, the first valve 916A is in the open position and the second valve 916B is in the closed position. In some embodiments, the controller 809 opens the first valve 916A and closes the second valve 916B. So configured, the foam 901 is fed to the delivery nozzle 908 via the first fluid passageway 905. The biasing force of the spring 950A is sufficient to bias the foam washing flap 929 in the open position when the delivery nozzle 908 delivers the foam 901. The foam 901 exits the delivery nozzle 908 through the foam opening 966 and the outlet openings 914.

FIG. 9B illustrates the wash apparatus 900 in the liquid washing mode. In the liquid washing mode, the first valve 916A is in the closed position and the second valve 916B is in the open position. In some embodiments, the controller 809 closes the first valve 916A and opens second valve 916B. So configured, the liquid 903 is fed to the delivery nozzle 908 via the second fluid passageway 907. The liquid 903 exerts a force sufficient to overcome the biasing force of the spring 950A and, accordingly, the foam washing flap 929 is in the closed position in which the foam washing flap 929 seals the foam opening 966. The liquid 903 exits the delivery nozzle 908 through the outlet openings 914.

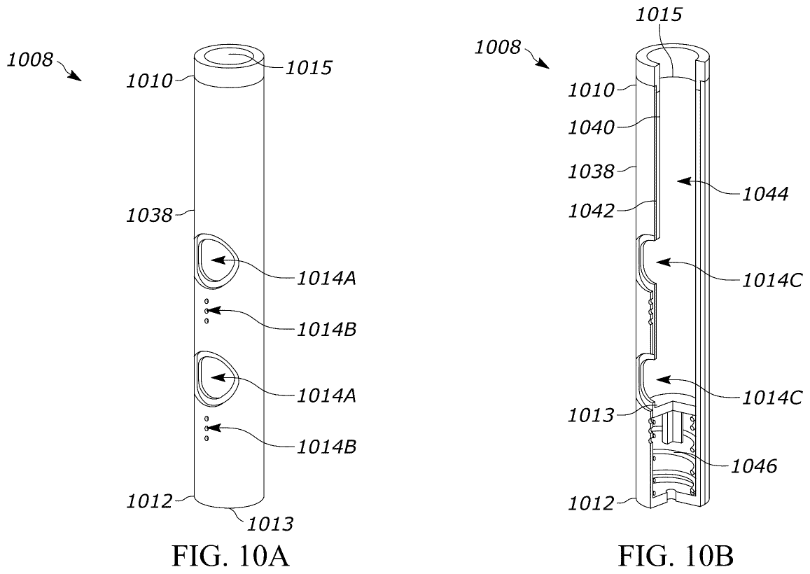

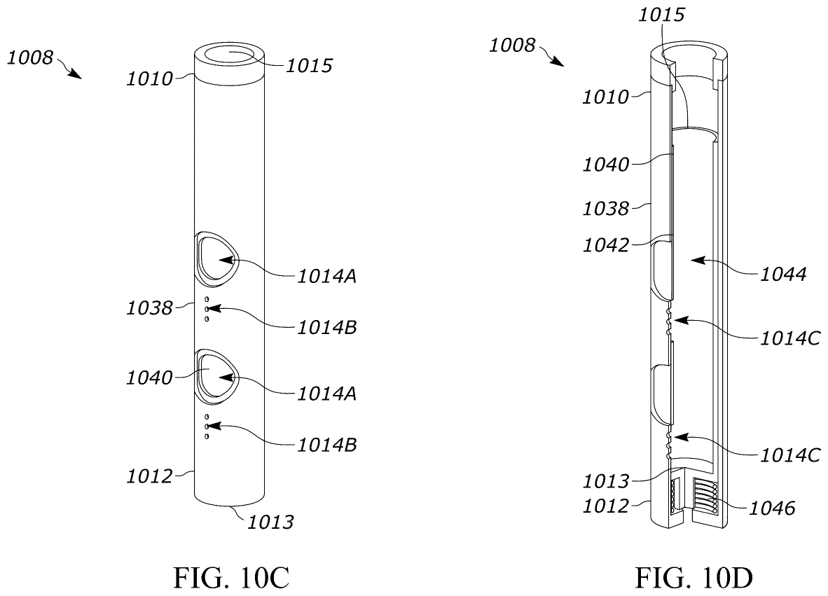

FIGS. 10A, 10B, 10C, and 10D illustrate a delivery nozzle 1008 that ingests foam from an external source and can be used with the wash system 800, according to a second embodiment. The delivery nozzle 1008 can deliver foam from an external source (e.g., a source that is external to the wash system 800). The wash apparatus 1000 lacks a porous structure or other device for internal foam generation. The delivery nozzle 1008 is operable to switch between a foam washing mode (FIGS. 10A and 10B) and a liquid washing mode (FIGS. 10C and 10D). In some embodiments, the delivery nozzle 1008 delivers a pressurized liquid (e.g., a high-pressure liquid) in the liquid washing mode. Specifically, the delivery nozzle 1008 is equipped with a first set of outlet openings for foam washing and a second set of outlet openings for liquid washing. The delivery nozzle 1008 includes a pressure-operated biasing mechanism that selectively exposes one of the two sets of outlet openings to switch between the foam washing and liquid washing modes.

The delivery nozzle 1008 is coupled to an upstream inlet assembly (not shown in FIGS. 10A-10D). In some embodiments, the inlet assembly is the inlet assembly 802 in FIG. 8, with the first fluid conduit 804 and the second fluid conduit 806. It is contemplated that the delivery nozzle 1008 can be used in the wash system 800 of FIG. 8. Elements of the second embodiment that are similar to those in FIG. 8 have been given similar reference numbers in the ten-hundred series. For example, the delivery nozzle 808 described in FIG. 8 is labeled as the delivery nozzle 1008 in FIGS. 10A, 10B, 10C, and 10D.

The delivery nozzle 1008 includes an outer sleeve 1038, an inner sleeve 1040, and a biasing member 1046. The delivery nozzle 1008 includes a feed end 1010 and a delivery end 1012. In some embodiments, the delivery nozzle 1008 defines an axial direction that extends from the feed end 1010 to the delivery end 1212 of the delivery nozzle 1008 and a circumferential direction extending about the axial direction.

The outer sleeve 1038 has an open end 1015 disposed at the feed end 1010 of the delivery nozzle 1008 and a closed end 1013 disposed at the delivery end 1012 of the delivery nozzle 1008. The outer sleeve 1038 has a first plurality of outlet openings 1014A and a second plurality of outlet openings 1014B. In some embodiments, the first plurality of outlet openings 1014A are larger than the second plurality of outlet openings 1014B. In some embodiments, the first plurality of outlet openings 1014A have a larger or approximately equal total open area than the second plurality of outlet openings 1014B. In some embodiments, a ratio of a total surface area of the first plurality of outlet openings 1014A to a total surface area of the second plurality of outlet openings 1014B is in the range of about 1:1 and about 10:1, and about 1:1 and about 5:1. In preferred forms, an average total area of the first plurality of outlet openings 1014A is about 0.049 sq-in, and an average total area of the second plurality of outlet openings 1014B is about 0.006 sq-in with a ratio of about 8:1.

The inner sleeve 1040 is disposed concentrically within the outer sleeve 1038. The inner sleeve 1040 and the outer sleeve 1038 define an outer casing 1042 of the delivery nozzle 1008 that encloses an interior nozzle cavity 1044. In some embodiments, the outer sleeve 1038 and the inner sleeve 1040 may further define a space between the outer sleeve 1038 and the inner sleeve 1040. While the embodiments shown depict the outer sleeve 1038, inner sleeve 1040, and consequent outer casing 1042 as circular, any alternate suitable shape, dimensions, and/or configurations may be used. The inner sleeve 1040 has an open end 1015 disposed at the feed end 1010 of the delivery nozzle 1008 and a closed end 1013 disposed at the delivery end 1012 of the delivery nozzle 1008. The inner sleeve 1040 has a third plurality of outlet openings 1014C.

In some embodiments, the first plurality of outlet openings 1014A, the second plurality of outlet openings 1014B, and the third plurality of outlet openings 1014C are disposed along the same position in the circumferential direction. In some embodiments, the third plurality of outlet openings 1014C are approximately the same size as the first plurality of outlet openings 1014A. In the illustrated embodiment, the first plurality of outlet openings 1014A includes two outlet openings 1014A, and the second plurality of outlet openings 1014B includes two sets of three outlet openings 1014B alternatingly spaced such that a portion of the second plurality of outlet openings 1014B is adjacent the delivery end 1012 of the delivery nozzle 1008 and a portion of the first plurality of outlet openings 1014A is spaced from the feed end 1010 of the delivery nozzle 1008. It is generally contemplated that there may be any alternate suitable number and/or configuration of outlet openings 1014A, 1014B, 1014C.

The biasing member 1046 is disposed between the closed end 1013 of the outer sleeve 1038 and the closed end 1013 of the inner sleeve 1040. The biasing member 1046 biases the closed end 1013 of the inner sleeve 1040 away from the closed end 1013 of the outer sleeve 1038. In some embodiments, the biasing member 1046 is in the form of a spring.

FIGS. 10A and 10B illustrate the wash apparatus 1000 in the foam washing mode. In the foam washing mode (FIGS. 10A and 10B), the inlet assembly ingests a foam from an external foam source (not shown) and supplies the foam to the delivery nozzle 1008. In the foam washing mode, a flow of a foam from the first fluid conduit (not shown) compresses the biasing member 1046 to align the third plurality of outlet openings 1014C with the first plurality of outlet openings 1014A.

FIGS. 10C and 10D illustrate the wash apparatus 1000 in the liquid washing mode. In the liquid washing mode (FIGS. 10C and 10D), the inlet assembly receives a liquid and supplies the liquid to the delivery nozzle 1008. In the liquid washing mode, a flow of liquid from the second fluid conduit (not shown) compresses the biasing member 1046 to align the third plurality of outlet openings 1014C with the second plurality of outlet openings 1014B.

In some forms, when not in the foam washing mode or the liquid washing mode, the biasing member 1046 may bias to a natural state in which the third plurality of outlet openings 1014C is not aligned with the first plurality of outlet openings 1014A or the second plurality of outlet openings 1014B. For example, the inner sleeve 1040 may block some or all of the first plurality of outlet openings 1014A and/or the some or all of second plurality of outlet openings 1014B when the biasing member 1046 is in the natural state. In some embodiments, in the natural state the biasing member 1046 may align the third plurality of outlet openings 1014C with either the first plurality of outlet openings 1014A or the second plurality of outlet openings 1014B.

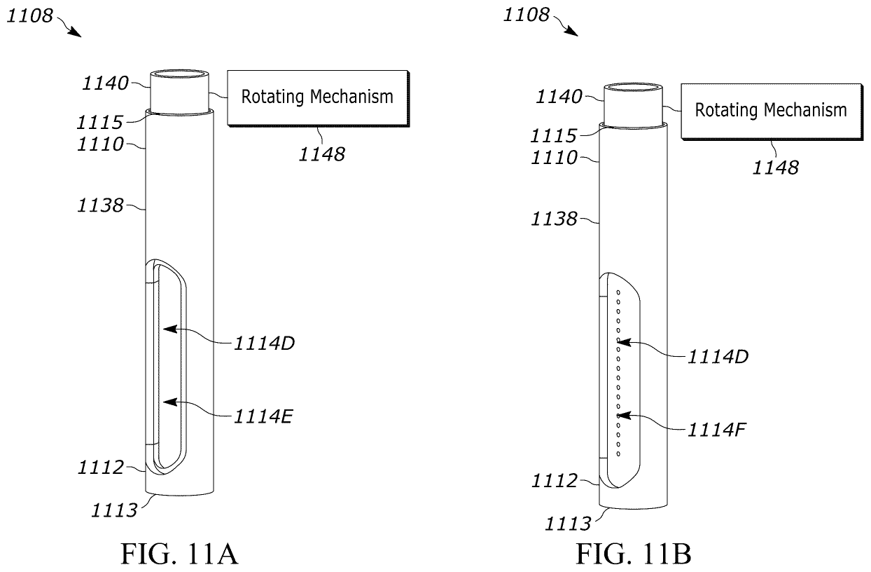

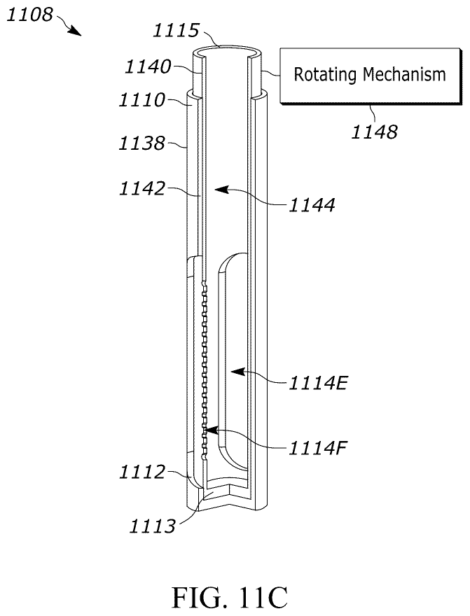

FIGS. 11A, 11B, and 11C illustrate a delivery nozzle 1108 that ingests foam from an external source and can be used with the wash system 800, according to a third embodiment. The delivery nozzle 1108 can deliver foam from an external source (e.g., a source that is external to the wash system 800). The wash apparatus 1100 lacks a porous structure or other device for internal foam generation. The delivery nozzle 1108 is operable to switch between a foam washing mode (FIG. 11A) and a liquid washing mode (FIGS. 11B and 11C). In some embodiments, the delivery nozzle 1108 delivers a pressurized liquid (e.g., a high-pressure liquid) in the liquid washing mode. Specifically, the delivery nozzle 1108 is equipped with a first set of outlet openings for foam washing and a second set of outlet openings for liquid washing. The delivery nozzle 1108 may include a rotating mechanism that selectively exposes one of the two sets of outlet openings to switch between the foam washing and liquid washing modes.

The delivery nozzle 1108 is coupled to an upstream inlet assembly (not shown in FIGS. 11A-11C). In some embodiments, the inlet assembly is the inlet assembly 802 in FIG. 8, with the first fluid conduit 804 and the second fluid conduit 806. It is contemplated that the delivery nozzle 1108 can be used in wash system 800 of FIG. 8. Elements of the third embodiment that are similar to those in FIG. 8 have been given similar reference numbers in the eleven-hundred series. For example, the delivery nozzle 808 described in FIG. 8 is labeled as the delivery nozzle 1108 in FIGS. 11A, 11B, and 11C.

The delivery nozzle 1108 includes an outer sleeve 1138 and an inner sleeve 1140. The outer sleeve 1138 has a window 1114D disposed therein. In some forms, the window 1114D may be the same or similar to any of the outlet openings described herein. In some embodiments, the outer sleeve 1138 is generally cylindrical and has an open end 1115 disposed at the feed end 1110 of the delivery nozzle 1108 and a closed end 1113 disposed at the delivery end 1112 of the delivery nozzle 1108.

The inner sleeve 1140 is disposed concentrically within the outer sleeve 1138. The inner sleeve 1140 and the outer sleeve 1138 define an outer casing 1142 of the delivery nozzle 1108 that encloses an interior nozzle cavity 1144. In some embodiments, the inner sleeve 1140 is generally cylindrical and has an open end 1115 disposed at the feed end 1110 of the delivery nozzle 1108 and a closed end 1113 disposed at the delivery end 1112 of the delivery nozzle 1108. The inner sleeve 1140 has a first plurality of outlet openings 1114E and a second plurality of outlet openings 1114F. In some embodiments, the first plurality of outlet openings 1114E are larger than the second plurality of outlet openings 1114F. In some embodiments, the first plurality of outlet openings 1114E have a larger or approximately equal total open area than the second plurality of outlet openings 1114F.

In some embodiments, a ratio of a total surface area of the first plurality of outlet openings 1114E to a total surface area of the second plurality of outlet openings 1114F is in the range of about 6:1 and about 10:1. In preferred forms, an average total area of the first plurality of outlet openings 1114E is about 0.049 sq-in, and an average total are of the second plurality of outlet openings 1114F is about 0.006 sq-in with a ratio of about 8:1. In some embodiments, a surface area of the window 1114D is larger than or approximately equal to a total surface area of the first plurality of outlet openings 1114E.

As shown in FIGS. 11A-11C, in some embodiments, the delivery nozzle 1108 further includes a rotating mechanism 1148 operatively coupled to at least one of the inner sleeve 1140 or the outer sleeve 1138 that is configured to rotate at least one of the inner sleeve 1140 or the outer sleeve 1138. The rotating mechanism 1148 may be any suitable rotating mechanism such as screw thread mechanisms, gears, and so forth. In some embodiments the rotating mechanism 1148 is a manual mechanism operable by a user, while in some embodiments the rotating mechanism 1148 is an automated mechanism including at least one motorized component. In an embodiment where the rotating mechanism 1148 is an automated mechanism, the automated mechanism may be controllable by an operator. In some embodiments, the rotating mechanism 1148 is in operative communication with the controller 809 of FIG. 8. So configured, the controller 809 may be configured to operate the rotating mechanism 1148 to switch between the foam washing and liquid washing modes.

FIG. 11A shows the delivery nozzle 1108 in the foam washing mode. In the foam washing mode, the window 1114D of the outer sleeve 1038 is aligned to expose the first plurality of outlet openings 1114E in the inner sleeve 1040. In the foam washing mode, a larger total area of outlet openings is exposed for the delivery of the foam through the delivery nozzle 1108.

FIGS. 11B and 11C show the delivery nozzle 1108 in the liquid washing mode. In the liquid washing mode, the window 1114D in the outer sleeve 1138 is aligned to expose the second plurality of outlet openings 1114F in the inner sleeve 1140. In the liquid washing mode, a smaller total area of outlet openings is exposed for the delivery of the liquid through the delivery nozzle 1108.

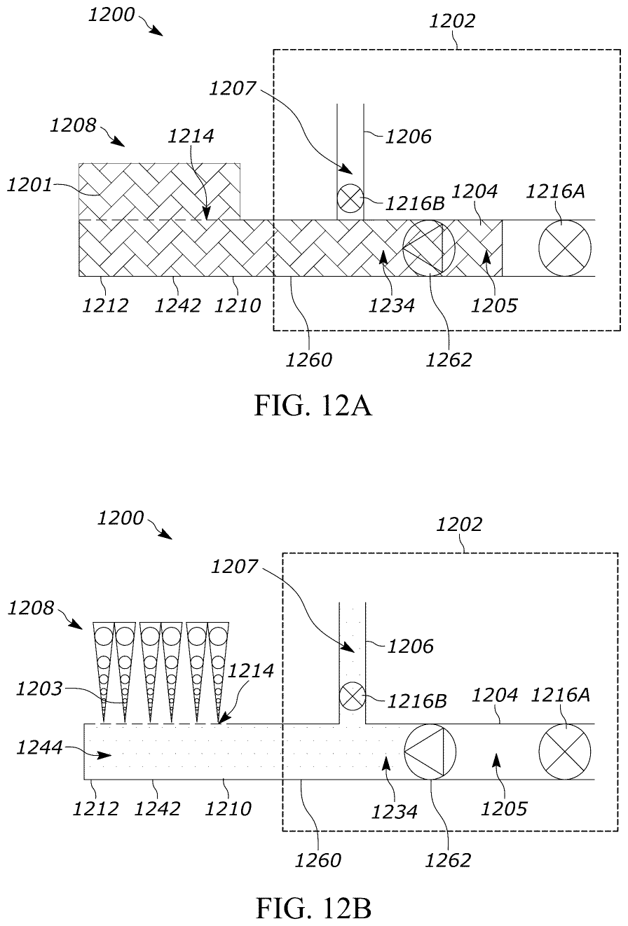

FIGS. 12A and 12B illustrate a wash apparatus 1200 that ingests foam from an external source and can be used with the wash system 800, according to a fourth embodiment. The wash apparatus 1200 can deliver foam from an external source (e.g., a source that is external to the wash system 800). The wash apparatus 1200 lacks a porous structure or other device for internal foam generation. The wash apparatus 1200 includes an inlet assembly 1202 and delivery nozzle 1208. The inlet assembly 1202 is operable to switch between a foam washing mode and a liquid washing mode. In some embodiments, the wash apparatus 1200 delivers a pressurized liquid (e.g., a high-pressure liquid) in the liquid washing mode. In the foam washing mode (FIG. 12A), the inlet assembly 1202 ingests foam from an external foam source (not shown) and supplies the foam 1201 to the delivery nozzle 1208. In the liquid washing mode (FIG. 12B), the inlet assembly 1202 receives a liquid 1203 and supplies the liquid 1203 to the delivery nozzle 1208. It is contemplated that the wash apparatus 1200 can be used in the wash system 800 of FIG. 8. Namely, the controller 809 of FIG. 8 can be used to operate the wash apparatus 1200 in the foam washing mode and the liquid washing mode. Elements of the fourth embodiment that are similar to those in FIG. 8 have been given similar reference numbers in the twelve-hundred series. For example, the inlet assembly 802 described in FIG. 8 is labeled as the inlet assembly 1202 in FIGS. 12A and 12B.

The inlet assembly 1202 includes a housing 1260. The housing 1260 defines an inlet chamber 1234. A first fluid conduit 1204 is coupled to the housing 1260 for delivering a foam 1201 to the inlet chamber 1234. A second fluid conduit 1206 is coupled to the housing 1260 for delivering a liquid 1203 to the inlet chamber 1234. In some embodiments, the liquid 1203 is a high-pressure liquid. The inlet chamber 1234 includes a check valve 1262. The check valve 1262 is disposed downstream of the first fluid conduit 1204 and upstream of the second fluid conduit 1206. In this manner, the check valve 1262 prevents or reduces the backflow of the liquid 1203 from the second fluid conduit 1206 into the first fluid conduit 1204.

The first fluid conduit 1204 defines a first fluid passageway 1205 for delivering the foam 1201 to the delivery nozzle 1208. A first valve 1216A is disposed in the first fluid passageway 1205 for controlling flow of the foam 1201 to the delivery nozzle 1208. The second fluid conduit 1206 defines a second fluid passageway 1207 for delivering the liquid 1203 to the delivery nozzle 1208. In some embodiments, the liquid 1203 is water or a hydrocarbon solvent. In some embodiments, the liquid 1203 is a high-pressure liquid. A second valve 1216B is disposed in the second fluid passageway 1207 for controlling flow of the liquid 1203 to the delivery nozzle 1208. In some embodiments, the controller 809 is in operative communication with the first valve 1216A and the second valve 1216B.

The delivery nozzle 1208 includes a feed end 1210 and a delivery end 1212. The feed end 1210 of the delivery nozzle 1208 is coupled to the inlet assembly 1202. The delivery nozzle 1208 includes an outer casing 1242 with at least one outlet opening 1214 formed therein. In some embodiments, the outer casing 1242 is generally cylindrical in shape. The outer casing 1242 may include any suitable number, size, shape, and/or configuration of the outlet openings 1214. In some embodiments, the outlet openings 1214 are disposed on a side of the delivery nozzle 1208.

FIG. 12A illustrates the wash apparatus 1200 in the foam washing mode. In the foam washing mode, the first valve 1216A is in the open position and the second valve 1216B is in the closed position. In some embodiments, the controller 809 opens the first valve 1216A and closes the second valve 1216B. So configured, the foam 1201 is fed to the delivery nozzle 1208 through the check valve 1262 via the first fluid passageway 1205. The foam 1201 exits the delivery nozzle 1208 through the outlet openings 1214.

FIG. 12B illustrates the wash apparatus 1200 in the liquid washing mode. In the liquid washing mode, the first valve 1216A is in the closed position and the second valve 1216B is in the open position. In some embodiments, the controller 809 closes the first valve 1216A and opens the second valve 1216B. So configured, the liquid 1203 is fed to the delivery nozzle 1208 via the second fluid passageway 1207. The check valve 1262 prevents or limits the flow of the liquid 1203 into the first fluid passageway 1205. The liquid 1203 exits the delivery nozzle 1208 through the outlet openings 1214.

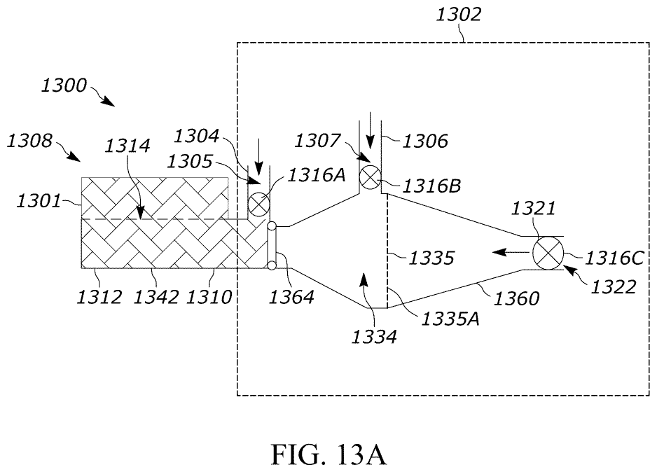

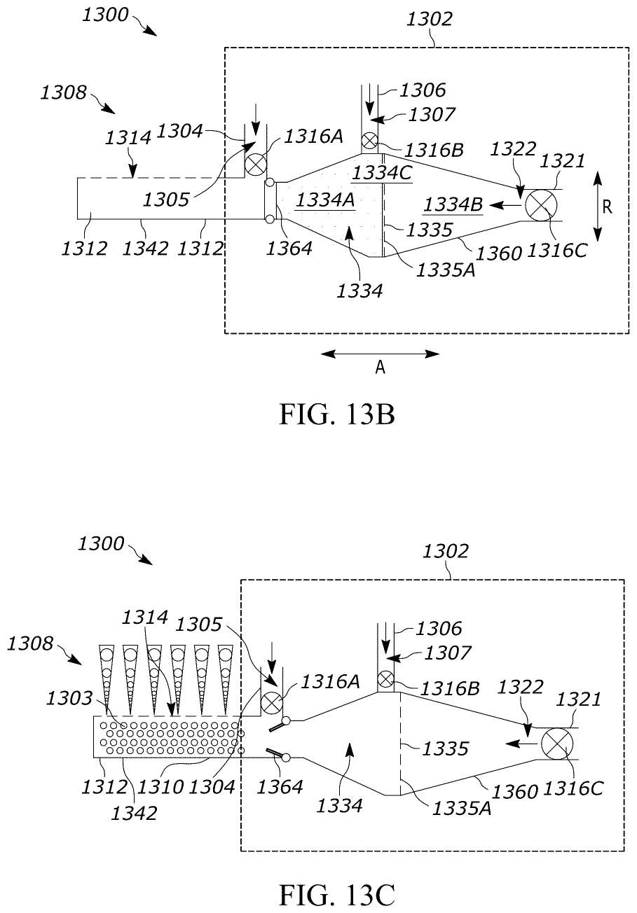

FIGS. 13A, 13B, and 13C illustrate a wash apparatus 1300 that ingests foam from an external source and can be used with the wash system 800, according to a fifth embodiment. The wash apparatus 1300 can deliver foam from an external source (e.g., a source that is external to the wash system 800). The wash apparatus 1300 lacks a porous structure or other device for internal foam generation. The wash apparatus 1300 includes an inlet assembly 1302 and a delivery nozzle 1308 positioned downstream of the inlet assembly 1302. The inlet assembly 1302 is operable to switch between a foam washing mode and a liquid washing mode. In some embodiments, the wash apparatus 1300 delivers an atomized liquid in the liquid washing mode. In the foam washing mode (FIG. 13A), the inlet assembly 1302 ingests foam from an external foam source (not shown) and supplies the foam 1301 to the delivery nozzle 1308. In the liquid washing mode (FIGS. 13B and 13C), the inlet assembly 1302 receives a liquid 1303 and supplies the liquid 1303 to the delivery nozzle 1308. In some embodiments, the wash apparatus 1300 delivers an atomized liquid in the liquid washing mode. It is contemplated that the wash apparatus 1300 can be used in the wash system 800 of FIG. 8. Namely, the controller 809 of FIG. 8 can be used to operate the wash apparatus 1300 in the foam washing and the liquid washing mode. Elements of the fifth embodiment that are similar to those in FIG. 8 have been given similar reference numbers in the thirteen-hundred series. For example, the inlet assembly 802 described in FIG. 8 is labeled as the inlet assembly 1302 in FIGS. 13A, 13B, and 13C.

The inlet assembly 1302 includes a first fluid conduit 1304 defining a first fluid passageway 1305 for delivering the foam 1301 to the delivery nozzle 1308. A first valve 1316A is disposed in the first fluid passageway 1305 for controlling flow of the foam 1301 into the delivery nozzle 1308. The inlet assembly 1302 also includes a second fluid conduit 1306 defining a second fluid passageway 1307 for delivering a liquid 1303 to the delivery nozzle 1308. In some embodiments, the liquid 1303 is a low-pressure liquid. A second valve 1316B is disposed in the second fluid passageway 1307 for controlling flow of the liquid into the delivery nozzle 1308. The inlet assembly 1302 also includes a third fluid conduit 1321 defining a third fluid passageway 1322 for delivering a gas to the delivery nozzle 1308. In some embodiments, the gas is a high-pressure gas such as high-pressure air. A third valve 1316C is disposed in the third fluid passageway 1322 for controlling flow of the gas into the delivery nozzle 1308.

The inlet assembly 1302 further includes a housing 1360. The housing 1360 defines an inlet chamber 1334. In some embodiments, the inlet chamber 1334 includes a fourth valve 1364. In some embodiments, the fourth valve 1364 is a butterfly valve. The second fluid conduit 1306, and the third fluid conduit 1321 are coupled to the housing 1360. In some embodiments, the first fluid conduit 1304 is coupled to a pipe upstream of the delivery nozzle 1308 (e.g., a feed pipe) or, in some aspects, to the delivery nozzle 1308 itself, and the first fluid conduit 1304 is disposed downstream of the fourth valve 1364. So configured, the first fluid conduit 1304 is configured to deliver the foam downstream of the inlet chamber 1334. In some embodiments, the second fluid conduit 1306 and the third fluid conduit 1321 are coupled to the housing 1360 and are disposed upstream of the fourth valve 1364. So configured, the second fluid conduit 1306 and the third fluid conduit 1321 deliver the liquid 1303 and the gas to the inlet chamber 1334. That is, the first fluid conduit 1304 is positioned closer to the delivery nozzle 1308 than the second fluid conduit 1306 and the third fluid conduit 1321. So configured, the fourth valve 1364 prevents or limits the flow of the foam 1301 into the second fluid conduit 1306 and the third fluid conduit 1321, for example, in the liquid washing mode. Also, the fourth valve 1364 can be employed to block a charge or quantity of the liquid 1303 delivered to the inlet chamber 1334, thereby retaining the liquid in the inlet chamber 1334 for a period of time.

The inlet chamber 1334 has a first end portion 1334A, a second end portion 1334B opposite the first end portion 1334A, and a middle portion 1334C disposed between the first end portion 1334A and the second end portion 1334B (see FIG. 13B). The inlet chamber 1334 may have an axial direction (A) extending along from the first end portion 1334A to the second end portion 1334B of the inlet chamber 1334 and a radial direction (R) extending perpendicular to the axial direction. In some embodiments, the first end portion 1334A and the second end portion 1334B may have a width defined along the radial direction that is smaller than a width of the middle portion 1334C. Similarly, in some embodiments, the first end portion 1334A and the second end portion 1334B may have a cross-sectional area when viewed along the axial direction that is smaller than a cross-sectional area of the middle portion 1334C. While the inlet chamber 1334 as illustrated has the shape of two adjacent conical portions, the inlet chamber 1334 can have any suitable shape that has an increasing/decreasing cross sectional area along the axial direction (A). The inlet chamber 1334 includes an inner wall 1335 with at least one hole 1335A formed in the inner wall 1335. The inner wall 1335 is disposed upstream of where the second fluid conduit 1306 is coupled to the housing 1360 and downstream of wherein the third fluid conduit 1321 is coupled to the housing 1360.

The inlet chamber 1334 creates a plenum for gas that gets injected into the liquid. The gas is injected into the inlet chamber 1334 from the third fluid conduit 1321 through the holes 1335A into the liquid that enters the inlet chamber 1334 from the second fluid conduit 1306. The first end portion 1334A of the inlet chamber 1334 is meant to create a holding chamber for increasing a total volume of liquid stored prior to injecting the gas. Both the first end portion 1334A and the second end portion 1334B could be cylindrical (e.g., larger than an inlet and/or outlet of the inlet chamber 1334) , but a cylindrical shape may not provide an ideal aerodynamic design for the second end portion 1334B and first end portion 1334A because the atomized liquid may impact on walls and form large droplets or rivulets of liquid. Thus, a generally conical shaped first end portion 1334A and second end portion 1334B may be advantageous.

In some embodiments, the controller 809 of FIG. 8 is in operative communication with one or more of the valves 1316A, 1316B, 1316C, 1364. In this manner, the controller 809 can actuate or operate the valves 1316A, 1316B, 1316C, 1364 to switch between an open position and a closed position and also various partially open positions. In some embodiments, a flow rate of the foam 1301 is adjustable via the first valve 1316A. In some embodiments, a flow rate of the liquid 1303 is adjustable via the second valve 1316B. In some embodiments, at least one of a pressure or a flow rate of the gas may be adjustable via the third valve 1316C.

The delivery nozzle 1308 includes a feed end 1310 and a delivery end 1312. The feed end 1310 of the delivery nozzle 1308 is coupled to the inlet assembly 1302. The delivery nozzle 1308 includes an outer casing 1342 with at least one outlet opening 1314 formed therein. In some embodiments, the outer casing 1342 is generally cylindrical in shape. The outer casing 1342 may include any suitable number, size, shape, and/or configuration of the outlet openings 1314. In some embodiments, the outlet openings 1314 are disposed on a side of the delivery nozzle 1308.

In some embodiments, the controller 809 operates one or more of the valves 1316A, 1316B, 1316C, 1364 to place the wash apparatus 1300 in the foam washing mode or the liquid washing mode.

In the foam washing mode (FIG. 13A), the first valve 1316A is in the open position. The second valve 1316B and the third valve 1316C are in the closed position. So configured, the foam 1301 is delivered to the inlet chamber 1334 from an external source (not shown). The flow of the liquid and the gas, however, are blocked from entering the inlet chamber 1334. Further, in some embodiments, the fourth valve 1364 is closed in the foam washing mode to prevent or limit the flow of foam into the inlet chamber 1334.

In the liquid washing mode (FIGS. 13B and 13C), the wash apparatus 1300 may deliver atomized liquid in a two-step process. In the first step (FIG. 13B), the first valve 1316A, the third valve 1316C, and the fourth valve 1364 are in the closed position. The second valve 1316B is in the open position. So configured, the liquid can be delivered to the inlet chamber 1334 via the second fluid conduit 1306 but the flow of gas is blocked. Additionally, in the first step (FIG. 13B), the flow of foam into the delivery nozzle 1308 is blocked. In this manner, a charge or predetermined quantity of the liquid can be delivered to the inlet chamber 1334. Because the fourth valve 1364 is closed, the predetermined quantity of the liquid is held in the inlet chamber 1334. The fourth valve 1364 remains closed under the weight of the liquid. In the second step (FIG. 13C), the first valve 1316A and the second valve 1316B are in the closed position. The third valve 1316C and the fourth valve 1364 are in the open position. So configured, the gas is delivered to the inlet chamber 1334 via the third fluid conduit 1321 and into the predetermined quantity of liquid. Because the fourth valve 1364 is open in the second step, the predetermined quantity of liquid and any entrained gas exits the inlet chamber 1334 into the delivery nozzle 1308. In the second step, the fourth valve 1364 opens due to the pressure of the gas supplied via the third fluid conduit 1321. The flow of the foam and the liquid are blocked in the second step. It is contemplated that this two-step process may form an atomized liquid in the inlet chamber 1334.

In some embodiments, in the liquid washing mode, the first valve 1316A and the third valve 1316C are closed to block the flow of foam and gas, respectively, into the delivery nozzle 1308. The second valve 1316B and the fourth valve 1364 are open to permit the flow of liquid to the delivery nozzle 1308.

In some embodiments, in the liquid washing mode, pulsed liquid droplet delivery is achieved by cycling between a liquid fill phase (e.g., with the second valve 1316B open and other valves closed to deliver a charge of liquid to the inlet chamber 1334) and a gas pulse phase (e.g., with the third valve 1316C open, which opens the fourth valve 1316D with the pressure of the gas, and with the first valve 1316A and the second valve 1316B closed) to accelerate and/or atomize the liquid into droplets.

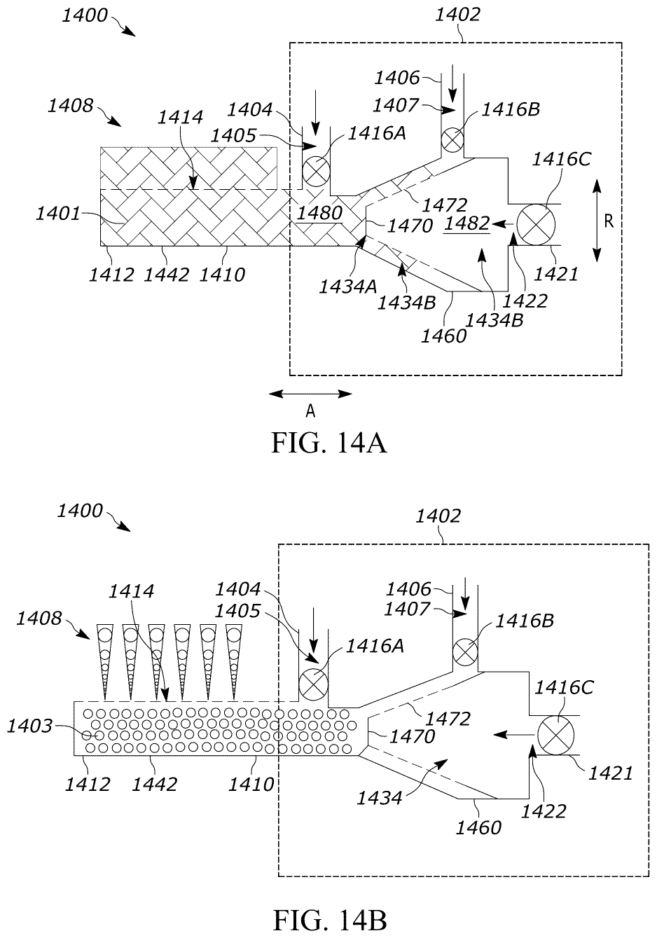

FIGS. 14A and 14B illustrate a wash apparatus 1400 that ingests foam from an external source and can be used with the wash system 800, according to a sixth embodiment. The wash apparatus 1400 can deliver foam from an external source (e.g., a source that is external to the wash system 800). The wash apparatus 1400 lacks a porous structure or other structure for internal foam generation. The wash apparatus 1400 includes an inlet assembly 1402 and a delivery nozzle 1408 positioned downstream of the inlet assembly 1402. The inlet assembly 1402 is operable to switch between a foam washing mode and a liquid washing mode. In the foam washing mode (FIG. 14A), the inlet assembly 1402 ingests foam from an external foam source (not shown) and supplies the foam 1401 to the delivery nozzle 1408. In the liquid washing mode (FIG. 14B), the inlet assembly 1402 receives a liquid 1403 and supplies the liquid 1403 to the delivery nozzle 1408. In some embodiments, the wash apparatus 1400 delivers an atomized liquid in the liquid washing mode. It is contemplated that the wash apparatus 1400 can be used in the wash system 800 of FIG. 8. Namely, the controller 809 of FIG. 8 can be used to operate the wash apparatus 1400 in the foam washing and the liquid washing mode. Elements of the sixth embodiment that are similar to those in FIG. 8 have been given similar reference numbers in the fourteen-hundred series. For example, the inlet assembly 802 described in FIG. 8 is labeled as the inlet assembly 1402 in FIGS. 14A and 14B.

The inlet assembly 1402 includes a first fluid conduit 1404 defining a first fluid passageway 1405 for delivering the foam 1401 to the delivery nozzle 1408. A first valve 1416A is disposed in the first fluid passageway 1405 for controlling flow of the foam 1401 into the delivery nozzle 1408. The inlet assembly 1402 also includes a second fluid conduit 1406 defining a second fluid passageway 1407 for delivering a liquid to the delivery nozzle 1408. A second valve 1416B is disposed in the second fluid passageway 1407 for controlling flow of the liquid into the delivery nozzle 1408. The inlet assembly 1402 also includes a third fluid conduit 1421 defining a third fluid passageway 1422 for delivering a gas to the delivery nozzle 1408. In some embodiments, the gas is a high-pressure gas such as high-pressure air. A third valve 1416C is disposed in the third fluid passageway 1422 for controlling flow of the gas into the delivery nozzle 1408.

The inlet assembly 1402 further includes a housing 1460. The housing 1460 defines an inlet chamber 1434. The second fluid conduit 1406, and the third fluid conduit 1421 are coupled to the housing 1460. In some embodiments, the first fluid conduit 1404 is coupled to the delivery nozzle 1408 or a pipe upstream of the delivery nozzle 1408 (e.g., a feed pipe) and the first fluid conduit 1404 is disposed downstream second fluid conduit 1406 and the third fluid conduit 1421. So configured, the first fluid conduit 1404 is configured to deliver the foam 1401 downstream of the inlet chamber 1434. In some embodiments, the second fluid conduit 1406 and the third fluid conduit 1421 are coupled to the housing 1460 and are disposed upstream of the first fluid conduit 1404. So configured, the second fluid conduit 1406 and the third fluid conduit 1421 deliver the liquid 1403 and the gas to the inlet chamber 1434. That is, the first fluid conduit 1404 is positioned closer to the delivery nozzle 1408 than the second fluid conduit 1406 and the third fluid conduit 1421.

The inlet chamber 1434 has a first end portion 1434A that is coupled to the delivery nozzle 1408 and a second end portion 1434B opposite the first end portion 1434A (see FIG. 13A). The inlet chamber 1434 may have an axial direction (A) extending from the first end portion 1434A to the second end portion 1434B of the inlet chamber 1434 and a radial direction (R) extending perpendicular to the axial direction. In some embodiments, the first end portion 1434A has a width defined along the radial direction that is smaller than a width of the second end portion 1434B. Similarly, in some embodiments, the first end portion 1434A has a cross-sectional area when viewed along the axial direction that is smaller than a cross-sectional area of the second end portion 1434B.

The inlet chamber 1434 has an inner wall 1470 disposed therein. The inner wall 1470 divides the housing 1460 into a first chamber 1480 in fluid communication with the second fluid passageway 1407 and a second chamber 1482 in fluid communication with the third fluid passageway 1422. The inner wall 1470 defines at least one orifice 1472 to place the first chamber 1480 in fluid communication with the second chamber 1482. The inner wall 1470 may be tapered along the axial direction and, for example, have a width along the radial direction that decreases from an upstream end to a downstream end. In some embodiments, the inner wall 1470 is generally conical in shape. In some embodiments, the first fluid conduit 1404 is coupled to the housing 1460 downstream of the second fluid conduit 1406 and the third fluid conduit 1421. While the inlet chamber 1434 as illustrated has a generally conical shape, the inlet chamber 1434 can have any suitable shape that has a decreasing cross-sectional area along the axial direction (A).

The inlet chamber 1434 creates a plenum for gas that gets injected into the liquid. The gas is injected into the inlet chamber 1434 from the third fluid conduit 1421 through the orifice(s) 1472 into the liquid that enters the inlet chamber 1434 from the second fluid conduit 1406. The first end portion 1434A of the inlet chamber 1434 is meant to create a holding chamber for increasing a total volume of liquid stored prior to injecting the gas. In some embodiments, the inlet chamber 1434 may be cylindrical (e.g., larger than an inlet and/or outlet of the inlet chamber 1334), but a cylindrical shape may not provide an ideal aerodynamic design for the second end portion 1334B and first end portion 1334A because the atomized liquid may impact on walls and form large droplets or rivulets of liquid. Thus, a generally conical shape may be advantageous.

In some embodiments, the controller 809 of FIG. 8 is in operative communication with one or more of the valves 1416A, 1416B, 1416C. In this manner, the controller 809 can actuate or operate the valves 1416A, 1416B, 1416C to switch between an open position and a closed position and also various partially open positions. In some embodiments, a flow rate of the foam 1401 is adjustable via the first valve 1416A. In some embodiments, a flow rate of the liquid 1403 is adjustable via the second valve 1416B. In some embodiments, at least one of a pressure or a flow rate of the gas may be adjustable via the third valve 1416C.

The delivery nozzle 1408 includes a feed end 1410 and a delivery end 1412. The feed end 1410 of the delivery nozzle 1408 is coupled to the inlet assembly 1402. The delivery nozzle 1408 includes an outer casing 1442 with at least one outlet opening 1414 formed therein. In some embodiments, the outer casing 1442 is generally cylindrical in shape. The outer casing 1442 may include any suitable number, size, shape, and/or configuration of the outlet openings 1414. In some embodiments, the outlet openings 1414 are disposed on a side of the delivery nozzle 1408.

In some embodiments, the controller 809 operates one or more of the valves 1416A, 1416B, 1416C to place the wash apparatus 1400 in the foam washing mode or the liquid washing mode.

In the foam washing mode (FIG. 14A), the first valve 1416A is in the open position. The second valve 1416B and the third valve 1416C are in the closed position. So configured, the foam 1401 is delivered to the inlet chamber 1434 from an external source (not shown). The flow of the liquid and the gas, however, are blocked from entering the inlet chamber 1434.

In the liquid washing mode (FIG. 14B), the wash apparatus 1400 may deliver atomized liquid to the delivery nozzle 1408. In the liquid washing mode, the first valve 1416A is in the closed position. The second valve 1416B and the third valve 1416C are in the open position. So configured, the liquid and the gas are delivered to the inlet chamber 1434 via the second fluid conduit 1406 and the third fluid conduit 1421, respectively, but the flow of the foam is blocked. It is contemplated that injecting the gas into the liquid through the inner wall 1470 may generate an atomized liquid.

In some embodiments, in the liquid washing mode, pulsed liquid droplet delivery is achieved by cycling between a liquid fill phase (e.g., with the second valve 1416B open and other valves closed) and a gas pulse phase (e.g., with the third valve 1416C open and other valves closed) to accelerate and/or atomize the liquid into droplets. In some aspects, the liquid stream may be uninterrupted (e.g., with the second valve 1416B open) and the third valve 1416C cycled between the open and closed position to achieve a pulsed liquid droplet delivery.

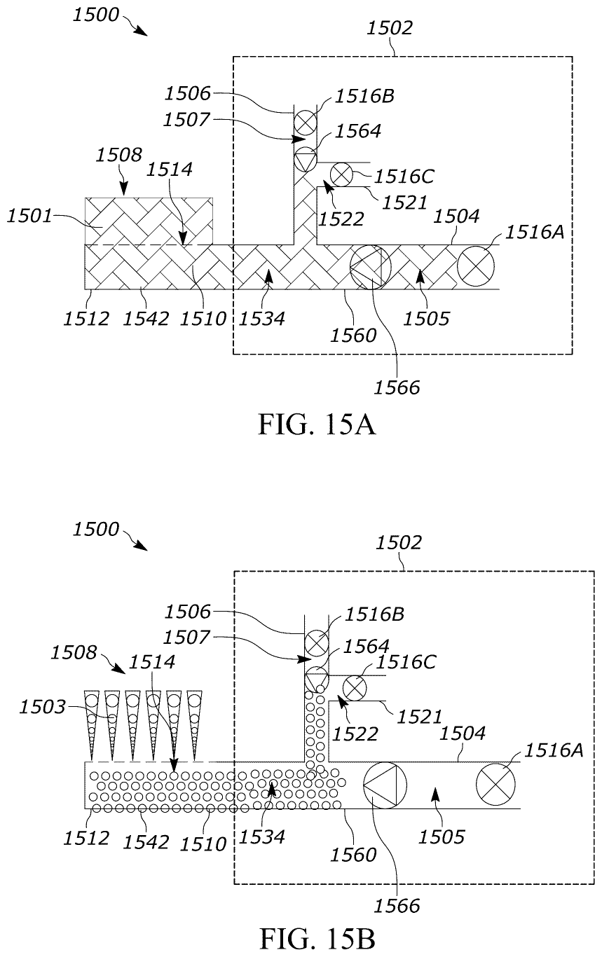

FIGS. 15A and 15B illustrate a wash apparatus 1500 that ingests foam from an external source and can be used with the wash system 800, according to a seventh embodiment. The wash apparatus 1500 can deliver foam from an external source (e.g., a source that is external to the wash system 800). The wash apparatus 1500 lacks a porous structure or other device for internal foam generation. The wash apparatus 1500 includes an inlet assembly 1502 and a delivery nozzle 1508 positioned downstream of the inlet assembly 1502. The inlet assembly 1502 is operable to switch between a foam washing mode and a liquid washing mode. In the foam washing mode (FIG. 15A), the inlet assembly 1502 ingests foam from an external foam source (not shown) and supplies the foam 1501 to the delivery nozzle 1508. In the liquid washing mode (FIG. 15B), the inlet assembly 1502 receives a liquid 1503 and supplies the liquid 1503 to the delivery nozzle 1508. In some embodiments, the wash apparatus 1500 delivers an atomized liquid in the liquid washing mode. It is contemplated that the wash apparatus 1500 can be used in the wash system 800 of FIG. 8. Namely, the controller 809 of FIG. 8 can be used to operate the wash apparatus 1500 in the foam washing mode and the liquid washing mode. Elements of the seventh embodiment that are similar to those in FIG. 8 have been given similar reference numbers in the fifteen-hundred series. For example, the inlet assembly 802 described in FIG. 8 is labeled as the inlet assembly 1502 in FIGS. 15A and 15B.

The inlet assembly 1502 includes a first fluid conduit 1504 defining a first fluid passageway 1505 for delivering the foam 1501 to the delivery nozzle 1508. A first valve 1516A is disposed in the first fluid passageway 1505 for controlling flow of the foam 1501 into the delivery nozzle 1508. The inlet assembly 1502 also includes a second fluid conduit 1506 defining a second fluid passageway 1507 for delivering a liquid 1503 to the delivery nozzle 1508. In some embodiments, the liquid 1503 is a low-pressure liquid. In some embodiments, pressure of the liquid 1503 can be set based on an ability to pump the liquid against any back pressure created by the gas stream. A second valve 1516B is disposed in the second fluid passageway 1507 for controlling flow of the liquid 1503 into the delivery nozzle 1508. A first check valve 1564 is disposed in the second fluid passageway 1507 downstream of the second valve 1516B. The inlet assembly 1502 also includes a third fluid conduit 1521 defining a third fluid passageway 1522 for delivering a gas to the delivery nozzle 1508. In some embodiments, the gas is a high-pressure gas such as high-pressure air. A third valve 1516C is disposed in the third fluid passageway 1522 for controlling flow of the gas into the delivery nozzle 1508.

The inlet assembly 1502 further includes a housing 1560. The housing 1560 defines an inlet chamber 1534. The inlet chamber 1534 includes a second check valve 1566 disposed therein. The first fluid conduit 1504 is coupled to the housing 1560 upstream of the second check valve 1566. The second fluid conduit 1506 is coupled to the housing 1560 downstream of the second check valve 1566. That is, the second fluid conduit 1506 is positioned closer to the delivery nozzle 1508 than the first fluid conduit 1504. So configured, the second check valve 1566 prevents or limits the backflow of the liquid into first fluid conduit 1504, for example, in the liquid washing mode. The third fluid conduit 1521 is coupled to the second fluid conduit 1506 such that the third fluid passageway 1522 supplies the gas into the second fluid passageway 1507. The third fluid conduit 1521 is coupled to the second fluid conduit 1506 downstream of the first check valve 1564. Thus, the first check valve 1564 may prevent or limit the backflow of the gas from the third fluid passageway 1522 into the second fluid passageway 1507, for example, in the liquid washing mode.

In some embodiments, the controller 809 of FIG. 8 is in operative communication with the valves 1516A, 1516B, 1516C. In this manner, the controller 809 can actuate or operate the valves 1516A, 1516B, 1516C to switch between an open position and a closed position and also various partially open positions. In some embodiments, a flow rate of the foam 1501 is adjustable via the first valve 1516A. In some embodiments, a flow rate of the liquid 1503 is adjustable via the second valve 1516B. In some embodiments, at least one of a pressure or a flow rate of the gas may be adjustable via the third valve 1516C.

The delivery nozzle 1508 includes a feed end 1510 and a delivery end 1512. As illustrated, the delivery nozzle 1508 is elongated from the delivery end 1512 to the feed end 1510. The feed end 1510 of the delivery nozzle 1508 is coupled to the inlet assembly 1502. The delivery nozzle 1508 includes an outer casing 1542 with at least one outlet opening 1514 formed therein. In some embodiments, the outer casing 1542 is generally cylindrical in shape. The outer casing 1542 may include any suitable number, size, shape, and/or configuration of the outlet openings 1514. In some embodiments, the outlet openings 1514 are disposed on a side of the delivery nozzle 1508.

In some embodiments, the controller 809 operates one or more of the valves 1516A, 1516B, 1516C to place the wash apparatus 1500 in the foam washing mode or the liquid washing mode.

In the foam washing mode (FIG. 15A), the first valve 1516A is in the open position. The second valve 1516B and the third valve 1516C are in the closed position. So configured, the foam 1501 is delivered to the inlet chamber 1534 from an external source (not shown). The flow of the liquid and the gas, however, are blocked from entering the inlet chamber 1534.

In the liquid washing mode (FIG. 15B), the first valve 1516A is in the closed position. The second valve 1516B and the third valve 1516C are in the open position. So configured, the liquid (e.g., a low-pressure liquid) and the gas (e.g., a high-pressure gas) flow into the inlet chamber 1534. It is contemplated that the combination of injection of a low-pressure liquid and a high-pressure gas may form an atomized liquid in the inlet chamber 1534. The liquid and gas are supplied to the delivery nozzle 1508 from the inlet chamber 1534.

In some embodiments, in the liquid washing mode, pulsed liquid droplet delivery is achieved by cycling between a liquid fill phase (e.g., with the second valve 1516B open and other valves closed) and a gas pulse phase (e.g., with the third valve 1516C open and other valves closed) to accelerate and/or atomize the liquid into droplets. In some aspects, the liquid stream may be uninterrupted (e.g., with the second valve 1516B open) and the third valve 1516C cycled between the open and closed position to achieve a pulsed liquid droplet delivery.

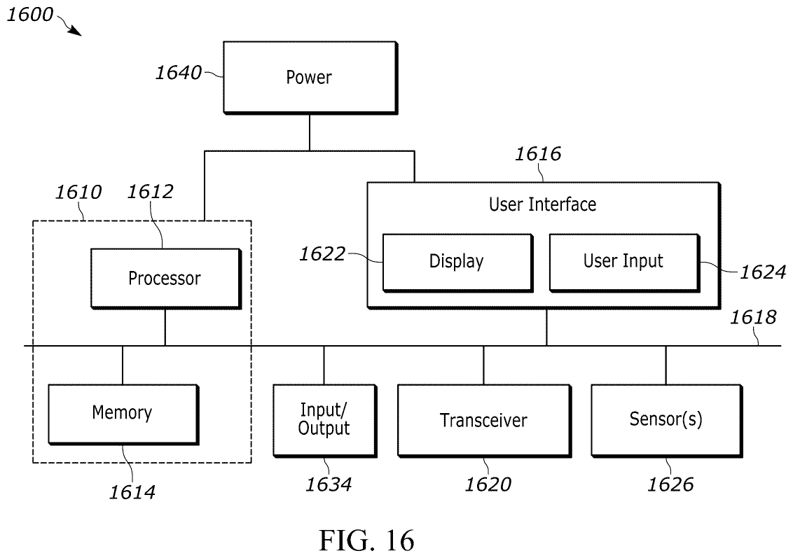

The circuits, circuitry, systems, devices, processes, methods, techniques, functionality, services, servers, sources, and the like described herein may be utilized, implemented, and/or run on many different types of devices and/or systems. FIG. 16 illustrates an exemplary system 1600 that may be used for implementing any of the components, circuits, circuitry, systems, functionality, apparatuses, processes, or devices of the wash systems 100, 500, 800, and/or other above or below mentioned systems or devices, or parts of such circuits, circuitry, functionality, systems, apparatuses, processes, or devices. For example, the system 1600 may be used to implement some or all of the wash systems 100, 500, 800, the controllers 109, 509, 809, the valve systems, the delivery nozzle systems, a central control circuit, a valve system control circuit, a delivery nozzle control circuit, user interface units, and/or other such components, circuitry, functionality and/or devices. However, the use of the system 1600 or any portion thereof is certainly not required.

By way of example, the system 1600 may comprise one or more processor modules or control circuits 1612, one or more memory 1614, and one or more paths, buses, communication links 1618 or the like. Some embodiments may include one or more user interfaces 1616, and/or one or more internal and/or external power sources or supplies 1640. The control circuit 1612 can be implemented through one or more processors, microprocessors, central processing unit, logic, local digital storage, firmware, software, and/or other control hardware and/or software, and may be used to execute or assist in executing the steps of the processes, methods, functionality and techniques described herein, and control various communications, decisions, programs, content, listings, services, interfaces, logging, reporting, etc. Further, in some embodiments, the control circuit 1612 can be part of control circuitry and/or a control system 1610, which may be implemented through one or more processors with access to one or more memory 1614 that can store instructions, code and the like that is implemented by the processors and/or control circuit 1612 to implement intended functionality. In some applications, the control circuit and/or memory may be distributed over a communications network (e.g., LAN, WAN, Internet) providing distributed and/or redundant processing and functionality. Again, the system 1600 may be used to implement one or more of the above or below, or parts of, components, circuits, systems, processes, and the like. For example, the system may implement the controller with the control circuit being a controller control circuit, the valve system with the control circuit being a valve control circuit, delivery nozzle system with the control circuit being a delivery nozzle control circuit, or other components.

The user interface 1616 can allow a user to interact with the system 1600 and receive information through the system. In some instances, the user interface 616 includes a display 1622 and/or one or more user inputs 1624, such as buttons, touch screen, track ball, keyboard, mouse, etc., which can be part of or wired or wirelessly coupled with the system 1600. Typically, the system 1600 further includes one or more communication interfaces, ports, transceivers 1620 and the like allowing the wash systems 100, 500, 800 to communicate over a communication bus, a distributed computer and/or communication network 111, 511, 811 (e.g., a local area network (LAN), the Internet, wide area network (WAN), etc.), communication link 1618, other networks or communication channels with other devices and/or other such communications or combination of two or more of such communication methods. Further the transceiver 1620 can be configured for wired, wireless, optical, fiber optical cable, satellite, or other such communication configurations or combinations of two or more of such communications. Some embodiments include one or more input/output (I/O) ports and/or I/O interfaces 1634 that allow one or more devices to couple with the system 1600. The I/O ports can be substantially any relevant port or combinations of ports, such as but not limited to USB, Ethernet, or other such ports. The I/O interface 1634 can be configured to allow wired and/or wireless communication coupling to external components. For example, the I/O interface can provide wired communication and/or wireless communication (e.g., Wi-Fi, Bluetooth, cellular, RF, and/or other such wireless communication), and in some instances may include any known wired and/or wireless interfacing device, circuit and/or connecting device, such as but not limited to one or more transmitters, receivers, transceivers, or combination of two or more of such devices.

In some embodiments, the system may include one or more sensors 1626 to provide information to the system and/or sensor information that is communicated to another component. The sensors can include substantially any relevant sensor, such as distance measurement sensors (e.g., optical units, sound/ultrasound units, etc.), optical-based scanning sensors to sense and read optical patterns (e.g., bar codes), radio frequency identification (RFID) tag reader sensors capable of reading RFID tags in proximity to the sensor, and other such sensors. The foregoing examples are intended to be illustrative and are not intended to convey an exhaustive listing of all possible sensors. Instead, it will be understood that these teachings will accommodate sensing any of a wide variety of circumstances in a given application setting.

The system 1600 comprises an example of a control and/or processor-based system with the control circuit 1612. Again, the control circuit 1612 can be implemented through one or more processors, controllers, central processing units, logic, software, and the like. Further, in some implementations the control circuit 1612 may provide multiprocessor functionality.

The memory 1614, which can be accessed by the control circuit 1612, typically includes one or more processor-readable and/or computer-readable media accessed by at least the control circuit 1612, and can include volatile and/or nonvolatile media, such as RAM, ROM, EEPROM, flash memory and/or other memory technology. Further, the memory 1614 is shown as internal to the control system 1610; however, the memory 1614 can be internal, external or a combination of internal and external memory. Similarly, some or all of the memory 1614 can be internal, external or a combination of internal and external memory of the control circuit 1612. The external memory can be substantially any relevant memory such as, but not limited to, solid-state storage devices or drives, hard drive, one or more of universal serial bus (USB) stick or drive, flash memory secure digital (SD) card, other memory cards, and other such memory or combinations of two or more of such memory, and some or all of the memory may be distributed at multiple locations over the communication network (e.g., network 111, network 511, network 811). The memory 1614 can store code, software, executables, scripts, data, content, lists, programming, programs, log or history data, user information, customer information, product information, and the like. While FIG. 16 illustrates the various components being coupled together via a bus, it is understood that the various components may actually be coupled to the control circuit and/or one or more other components directly.

The terms and expressions used herein have the ordinary technical meaning as is accorded to such terms and expressions by persons skilled in the technical field as set forth above except where different specific meanings have otherwise been set forth herein. The word “or” when used herein shall be interpreted as having a disjunctive construction rather than a conjunctive construction unless otherwise specifically indicated. The terms “coupled,” “fixed,” “attached to,” and the like refer to both direct coupling, fixing, or attaching, as well as indirect coupling, fixing, or attaching through one or more intermediate components or features, unless otherwise specified herein.

The singular forms “a”, “an”, and “the” include plural references unless the context clearly dictates otherwise.

The terms “forward” and “aft” refer to relative positions within a gas turbine engine, with forward referring to a position closer to an engine inlet and aft referring to a position closer to an engine nozzle or exhaust. The terms “upstream” and “downstream” refer to the relative direction with respect to fluid flow in a fluid pathway. For example, “upstream” refers to the direction from which the fluid flows, and “downstream” refers to the direction to which the fluid flows.

Approximating language, as used herein throughout the specification and claims, is applied to modify any quantitative representation that could permissibly vary without resulting in a change in the basic function to which it is related. Accordingly, a value modified by a term or terms such as “about”, “approximately”, and “substantially”, are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin.

Further aspects of the disclosure are provided by the subject matter of the following clauses:

A wash system for a gas turbine engine comprising: an inlet assembly comprising: a housing defining a mixing chamber; a porous structure disposed in the housing; a first fluid conduit coupled to the housing, the first fluid conduit defining a first fluid passageway for delivering a gas, the first fluid conduit in fluid communication with a gas source; a second fluid conduit coupled to the housing, the second fluid conduit defining a second fluid passageway for delivering a detergent, the second fluid conduit in fluid communication with a detergent source; and a third fluid conduit coupled to the housing, the third fluid conduit defining a third fluid passageway for delivering a liquid, the third fluid conduit in fluid communication with a liquid source; a delivery nozzle that is elongated along a longitudinal axis from a feed end to a delivery end, the feed end of the delivery nozzle coupled to the inlet assembly, the delivery end of the delivery nozzle comprising at least one outlet opening; a plurality of valves to control fluid flow into the delivery nozzle, the plurality of valves including a first valve in the first fluid passageway, a second valve in the second fluid passageway, and a third valve in the third fluid passageway; and a controller configured to actuate the plurality of valves to cause the wash system to switch between a foam washing mode and a liquid washing mode, wherein the inlet assembly generates a foam in the mixing chamber in the foam washing mode using the gas from the first fluid conduit and the detergent from the second fluid conduit and delivers the liquid to the delivery nozzle in the liquid washing mode.

A wash system for a gas turbine engine comprising: an inlet assembly comprising: a housing defining a mixing chamber with a porous structure therein; a first fluid conduit in fluid communication with a gas source; a second fluid conduit in fluid communication with a detergent source; and a third fluid conduit in fluid communication with a liquid source; a delivery nozzle coupled to the inlet assembly; a plurality of valves to control fluid flow from the first fluid conduit, the second fluid conduit, and the third fluid conduit into the delivery nozzle; and a controller configured to actuate the plurality of valves to cause the wash system to switch between a foam washing mode and a liquid washing mode, wherein the inlet assembly delivers foam to the delivery nozzle in the foam washing mode and delivers liquid from the liquid source to the delivery nozzle in the liquid washing mode.

The wash system of any preceding clause, wherein the first fluid conduit defines a first fluid passageway for delivering gas from the gas source, wherein the second fluid conduit defines a second fluid passageway for delivering a detergent from the detergent source, wherein the third fluid conduit defines a third fluid passageway for delivering the liquid from the liquid source, and wherein the plurality of valves includes a first valve in the first fluid conduit, a second valve in the second fluid conduit, and a third valve in the third fluid conduit.

The wash system of any preceding clause, wherein in the foam washing mode the first valve and the second valve are open and the third valve is closed; and wherein in the liquid washing mode the first valve and the second valve are closed and the third valve is open.

The wash system of any preceding clause, wherein the gas source includes at least one of a gas storage tank, a plant air system, or a compressor.

The wash system of any preceding clause, wherein the liquid source includes a liquid tank, wherein the liquid source is operatively coupled to a pump for delivering the liquid to the delivery nozzle through the second fluid passageway, and wherein the detergent source includes a detergent tank, wherein the detergent source is operatively coupled to a pump for delivering the detergent to the inlet assembly through the third fluid passageway.

The wash system of any preceding clause, wherein one or more of the liquid tank, the detergent tank, the gas storage tank, and the compressor is disposed on a mobile cart.

The wash system of any preceding clause, wherein the liquid comprises at least one of water or a hydrocarbon solvent, and wherein the gas comprises at least one of air or nitrogen.

The wash system of any preceding clause, wherein a flow rate of the foam in the foam washing mode is in the range of about 0.01 gallons per minute to 0.08 gallons per minute, and wherein a flow rate of the liquid in the liquid washing mode is in the range of about 0.5 gallons per minute to 7 gallons per minute.

The wash system of any preceding clause, wherein the detergent comprises at least one of an organic acidic component or a surfactant.

The wash system of any preceding clause, wherein the porous structure is at least one of a mesh material, a sintered metal material, or an additively printed porous structure.

The wash system of any preceding clause, wherein the delivery nozzle comprises a pressure operated valve assembly for controlling foaming of the liquid, the pressure operated valve assembly including: a retaining wall that extends across the first fluid conduit, the retaining wall having at least one orifice to allow for flow of the gas through the retaining wall into the mixing chamber; a receiving chamber defined by the retaining wall and a portion of the first fluid conduit, wherein the porous structure that is movable between a first position for the foam washing mode in which at least a portion of the porous structure is disposed within the mixing chamber and a second position for the liquid washing mode in which the porous structure is seated within the receiving chamber; and a biasing member disposed within the mixing chamber and operatively coupled to the porous structure, the biasing member biasing the porous structure toward the second position.

The wash system of any preceding clause, wherein the biasing member is a spring.

The wash system of any preceding clause, wherein the porous structure has a first face disposed adjacent to the retaining wall and a second face disposed opposite the first face, and wherein the biasing member is coupled to the second face of the porous structure.

The wash system of any preceding clause, wherein the second fluid conduit and the third fluid conduit are coupled to the mixing chamber upstream of the first fluid conduit.

The wash system of any preceding clause, wherein the second fluid conduit and the third fluid conduit are coupled to the mixing chamber upstream of the pressure operated valve assembly.

The wash system of any preceding clause, and wherein in the foam washing mode the first valve is open to permit flow of gas through the first fluid passageway, the second valve is open to permit flow of detergent through the second fluid passageway, and the third valve is closed to block flow of fluid through the third fluid passageway.

The wash system of any preceding clause, wherein in the liquid washing mode the first valve is closed to block flow of gas through the first fluid passageway resulting in the porous structure being displaced adjacent to the retaining wall, the second valve is closed to block flow of detergent through the second fluid passageway, and the third valve is open to permit flow of fluid through the third fluid passageway.

The wash system of any preceding clause, wherein the liquid is a high-pressure liquid.

The wash system of any preceding clause, further comprising: a check valve disposed in the mixing chamber, the porous structure is fixed upstream of the check valve; wherein the first fluid conduit and the second fluid conduit are coupled to the mixing chamber upstream of the check valve, and wherein the third fluid conduit is coupled to the mixing chamber downstream of the check valve.

The wash system of any preceding clause, wherein the third fluid conduit is disposed downstream of the first fluid conduit and the second fluid conduit.

The wash system of any preceding clause, wherein in the foam washing mode the first valve and the second valve are open and the third valve is closed.

The wash system of any preceding clause, wherein in the liquid washing mode the first valve and the second valve are closed and the third valve is open.

The wash system of any preceding clause, wherein the liquid is a high-pressure liquid.

The wash system of any preceding clause, wherein the gas is a first gas and the gas source is a first gas source, and wherein the wash system further comprises: a fourth fluid conduit coupled to the third fluid conduit, the fourth fluid conduit defining a fourth fluid passageway for delivering a second gas, the fourth fluid conduit in fluid communication with a second gas source, the plurality of valves further including a fourth valve in the fourth fluid passageway; and a check valve disposed in the mixing chamber, the porous structure is positioned upstream of the check valve; wherein the first fluid conduit and the second fluid conduit are coupled to the mixing chamber upstream of the check valve, and wherein the third fluid conduit and the fourth fluid conduit are coupled to the mixing chamber downstream of the check valve.

The wash system of any preceding clause, wherein the third fluid conduit is disposed downstream of the first fluid conduit and the second fluid conduit.

The wash system of any preceding clause, wherein the first gas is low-pressure gas and the second gas is high-pressure gas.

The wash system of any preceding clause, wherein the check valve is a first check valve and wherein the wash system further comprises: a second check valve disposed in the third fluid passageway, the second check valve positioned downstream of the third valve and upstream of where the fourth fluid conduit is coupled to the third fluid conduit.

The wash system of any preceding clause, wherein in the foam washing mode the first valve and the second valve are open and the third valve and the fourth valve are closed.

The wash system of any preceding clause, wherein in the liquid washing mode the first valve and the second valve are closed and the third valve and the fourth valve are open resulting in an atomized liquid delivery.

A wash system for a gas turbine engine comprising: an inlet assembly comprising: a first fluid conduit defining a first fluid passageway for delivering a gas, the first fluid conduit in fluid communication with a gas source; and a second fluid conduit defining a second fluid passageway for delivering a detergent, the second fluid conduit in fluid communication with a detergent source; a delivery nozzle comprising an outer casing that defines an interior nozzle cavity, a porous structure disposed in at least a portion of the interior nozzle cavity, the delivery nozzle elongated along a longitudinal axis from a feed end to a delivery end, the feed end of the delivery nozzle coupled to the inlet assembly, the outer casing defining at least one outlet opening; a regulator controlling gas flow into the delivery nozzle, the regulator disposed in the first fluid passageway; and a controller configured to operate the regulator to cause the wash system to switch between a foam washing mode and a liquid washing mode, wherein the controller sets the regulator to a low pressure in the foam washing mode to generate a foam and sets the regulator to a high pressure in the liquid washing mode to deliver liquid detergent.

A wash system for a gas turbine engine comprising: an inlet assembly comprising: a first fluid conduit in fluid communication with a gas source; and a second fluid conduit in fluid communication with a detergent source; a delivery nozzle coupled to the inlet assembly, the delivery nozzle having a porous structure disposed therein; a regulator controlling gas flow into the delivery nozzle, the regulator disposed in the first fluid conduit; and a controller configured to operate the regulator to cause the wash system to switch between a foam washing mode and a liquid washing mode, wherein the controller sets the regulator to a low pressure in the foam washing mode to generate a foam and sets the regulator to a high pressure in the liquid washing mode to deliver liquid detergent.

The wash system of any preceding clause, wherein the delivery nozzle comprises an outer casing that defines an interior nozzle cavity, the delivery nozzle elongated along a longitudinal axis from a feed end to a delivery end, the feed end of the delivery nozzle coupled to the inlet assembly, the outer casing defining at least one outlet opening.

The wash system of any preceding clause, wherein the gas source includes at least one of a gas storage tank, a plant air system, or a compressor.

The wash system of any preceding clause, wherein the detergent source includes a liquid tank, and wherein the detergent source is operatively coupled to a pump for delivering the detergent to the delivery nozzle through the second fluid passageway.

The wash system of any preceding clause, wherein the liquid tank is disposed on a mobile cart.

The wash system of any preceding clause, wherein a flow rate of the detergent in the foam washing mode is in the range of about 0.01 gallons per minute to 0.08 gallons per minute, and wherein a flow rate of the detergent in the liquid washing mode is in the range of about 0.5 gallons per minute to 7 gallons per minute.

The wash system of any preceding clause, wherein the porous structure is at least one of a mesh material, a sintered metal material, or an additively printed porous structure.

The wash system of any preceding clause, wherein the delivery nozzle further comprises: a first inner wall disposed in the interior nozzle cavity, the first inner wall dividing the interior nozzle cavity into a first chamber that is in fluid communication with the first fluid conduit and a second chamber in fluid communication with the second fluid conduit; and a second inner wall disposed in the interior nozzle cavity, the second inner wall defining at least a portion of a mixing chamber disposed at the delivery end of the delivery nozzle, the mixing chamber in fluid communication with the first chamber, the second chamber, and the at least one outlet opening, the mixing chamber including the porous structure disposed therein for generating the foam in the foam washing mode.

The wash system of any preceding clause, of clause 34, wherein the delivery nozzle delivers an atomized liquid detergent in the liquid washing mode.

The wash system of any preceding clause, wherein the outer casing of the delivery nozzle has a cylindrical shape that is closed at the delivery end and that has one or more inlet openings at the feed end.

The wash system of any preceding clause, wherein the delivery nozzle defines an axial direction that extends parallel to the longitudinal axis of the delivery nozzle, a radial direction, and a circumferential direction extending about the axial direction; and wherein the first inner wall of the delivery nozzle extends through the interior nozzle cavity in the axial direction dividing the interior nozzle cavity into the first chamber and the second chamber.

The wash system of any preceding clause, wherein the delivery nozzle has a proximal end adjacent to the inlet assembly and a distal end opposite the proximal end, and wherein the mixing chamber is disposed at the distal end of the delivery nozzle.

The wash system of any preceding clause, wherein the second inner wall of the delivery nozzle extends radially across the second chamber from the first inner wall to the outer casing of the delivery nozzle.

The wash system of any preceding clause, wherein the first inner wall has a proximal end adjacent to the inlet assembly and a distal end opposite the proximal end, and wherein the distal end of the first inner wall includes a plurality of holes in fluid communication with the mixing chamber.

The wash system of any preceding clause, wherein the first inner wall of the delivery nozzle is an annular wall that extends axially through the interior nozzle cavity and is spaced from the outer casing of the delivery nozzle, a first space between the first inner wall and the outer casing defining the first chamber and a second space within an interior of the annular wall defining the second chamber.

The wash system of any preceding clause, wherein the annular wall has a proximal end adjacent to the inlet assembly and a distal end opposite the proximal end, and wherein the distal end of the annular wall includes a plurality of holes in fluid communication with the mixing chamber.

The wash system of any preceding clause, wherein the delivery nozzle further comprises a third inner wall disposed within the interior nozzle cavity and spaced from the third inner wall to define the mixing chamber therebetween, wherein the second inner wall and the third inner wall extend radially across the delivery nozzle from the first inner wall to the outer casing of the delivery nozzle.

The wash system of any preceding clause, wherein the delivery nozzle has a proximal end adjacent to the inlet assembly and a distal end opposite the proximal end, wherein the mixing chamber is spaced from the distal end of the delivery nozzle.

A wash system for a gas turbine engine comprising: an inlet assembly comprising a first fluid conduit defining a first fluid passageway for delivering a foam and a second fluid conduit defining a second fluid passageway for delivering a liquid, the first fluid conduit in fluid communication with a foam source and the second fluid conduit in fluid communication with a liquid source; a delivery nozzle that is elongated along a longitudinal axis from a feed end to a delivery end, the feed end of the delivery nozzle coupled to the inlet assembly, the delivery nozzle comprising at least one outlet opening; a plurality of valves for controlling fluid flow into the delivery nozzle, the plurality of valves including a first valve in the first fluid passageway and a second valve in the second fluid passageway; and a controller configured to actuate the plurality of valves to cause the wash system to switch between a foam washing mode and a liquid washing mode, wherein the delivery nozzle delivers the foam in the foam washing mode and delivers the liquid in the liquid washing mode.

The wash system of any preceding clause, wherein the foam source includes a foam generation and delivery device.

The wash system of any preceding clause, wherein the liquid source includes a liquid tank, and wherein the liquid source is operatively coupled to a pump for delivering the liquid to the delivery nozzle through the second fluid passageway.

The wash system of any preceding clause, wherein the liquid tank is disposed on a mobile cart.

The wash system of any preceding clause, wherein the liquid comprises at least one of water or a hydrocarbon solvent.

The wash system of any preceding clause, wherein a flow rate of the foam in the foam washing mode is in the range of about 0.04 gallons per minute to 4.0 gallons per minute, and wherein a flow rate of the liquid in the liquid washing mode is in the range of about 0.5 gallons per minute to 7 gallons per minute.

The wash system of any preceding clause, wherein the delivery nozzle comprises: an outer casing that encloses an interior nozzle cavity, the outer casing including a foam washing opening and a liquid washing opening, a total area of the foam washing opening being larger than a total area of the liquid washing opening; and a foam washing flap coupled to the outer casing adjacent to the foam washing opening by a spring, the foam washing flap movable between a closed position in which the foam washing flap seals the foam washing opening and an open position in which the foam washing flap is spaced from the foam washing opening, the spring having a biasing force sufficient to bias the foam washing flap to the open position when the first fluid conduit delivers the foam to the interior nozzle cavity in the foam washing mode.

The wash system of any preceding clause, wherein a ratio of a total surface area of the foam washing opening to a total surface area of the liquid washing opening is in the range of about 6:1 and about 10:1.

The wash system of any preceding clause, wherein the at least one outlet opening is disposed on a side of the delivery nozzle; and wherein the foam washing opening is disposed at the delivery end of the delivery nozzle.

The wash system of any preceding clause, the spring is a torsion spring.

The wash system of any preceding clause, wherein the spring is designed such that the foam washing flap is in a fully closed position when a pressure in the interior nozzle cavity is in the range of 5 psi to 500 psi.

The wash system of any preceding clause, wherein the liquid exerts a force sufficient to overcome the biasing force of the spring and close the foam washing flap in the liquid washing mode.

The wash system of any preceding clause, wherein the delivery nozzle comprises: an outer sleeve having a first plurality of outlet openings and a second plurality of outlet openings, the first plurality of outlet openings having a larger or approximately equal total open area than the second plurality of outlet openings, the outer sleeve having an open end disposed at the feed end of the delivery nozzle and a closed end disposed at the delivery end of the delivery nozzle; an inner sleeve disposed concentrically within the outer sleeve, the inner sleeve having a third plurality of outlet openings, the inner sleeve and the outer sleeve defining an outer casing of the delivery nozzle that encloses an interior nozzle cavity, the inner sleeve having an open end disposed at the feed end of the delivery nozzle and a closed end disposed at the delivery end of the delivery nozzle; and a biasing member disposed between the closed end of the outer sleeve and the closed end of the inner sleeve, the biasing member biasing the closed end of the inner sleeve away from the closed end of the outer sleeve; wherein, in the foam washing mode a flow of the foam from the first fluid conduit compresses the biasing member to align the third plurality of outlet openings with the first plurality of outlet openings; and wherein in the liquid washing mode a flow of liquid from the second fluid conduit compresses the biasing member to align the third plurality of outlet openings with the second plurality of outlet openings.

The wash system of any preceding clause, wherein the biasing member is a spring.

The wash system of any preceding clause, wherein the delivery nozzle defines an axial direction that extends parallel to the longitudinal axis of the delivery nozzle and a circumferential direction extending about the axial direction, and wherein the first plurality of outlet openings, the second plurality of outlet openings, and the third plurality of outlet openings are disposed along the same position in the circumferential direction.

The wash system of any preceding clause, wherein the third plurality of outlet openings are approximately the same size as the first plurality of outlet openings.

The wash system of any preceding clause, wherein a ratio of a total surface area of the first plurality of outlet openings to a total surface area of the second plurality of outlet openings is in the range of about 1:1 and about 10:1.

The wash system of any preceding clause, wherein the delivery nozzle comprises: an outer sleeve having a window disposed therein; and an inner sleeve disposed concentrically within the outer sleeve, the inner sleeve having a first plurality of outlet openings and a second plurality of outlet openings, the first plurality of outlet openings having a larger or approximately equal total open area than the second plurality of outlet openings, the inner sleeve and outer sleeve defining an outer casing of the delivery nozzle that encloses an interior nozzle cavity; wherein in the foam washing mode the window in the outer sleeve aligned to expose the first plurality of outlet openings in the inner sleeve, and wherein in the liquid washing mode the window in the outer sleeve is aligned to expose the second plurality of outlet openings in the inner sleeve.

The wash system of any preceding clause, wherein a ratio of a total surface area of the first plurality of outlet openings to a total surface area of the second plurality of outlet openings is in the range of about 6:1 and about 10:1.

The wash system of any preceding clause, wherein a surface area of the window is larger than or approximately equal to a total surface area of the first plurality of outlet openings.

The wash system of any preceding clause, wherein the outer sleeve is generally cylindrical and has an open end disposed at the feed end of the delivery nozzle and a closed end disposed at the delivery end of the delivery nozzle.

The wash system of any preceding clause, further comprising a rotating mechanism operatively coupled to at least one of the inner sleeve or the outer sleeve and configured to rotate at least one of the inner sleeve or the outer sleeve.

The wash system of any preceding clause, wherein the inlet assembly further comprises: a third fluid conduit defining a third fluid passageway for delivering a gas, a third valve disposed in the third fluid passageway; a housing defining an inlet chamber; and a fourth valve disposed in the inlet chamber; wherein the first fluid conduit is coupled to the housing downstream of the fourth valve, and wherein the second fluid conduit and the third fluid conduit are coupled to the housing upstream of the fourth valve.

The wash system of any preceding clause, wherein in the foam washing mode the first valve is open and the second valve and the third valve are closed.

The wash system of any preceding clause, wherein the liquid washing mode comprises a first step and a second step, wherein in the first step the first valve and the third valve and the fourth valve are closed and the second valve is open to deliver a predetermined amount of liquid to the inlet chamber, and wherein in the second step the first valve and the second valve are closed and the third valve and the fourth valve are open to supply gas to the predetermined amount of liquid in the inlet chamber and deliver an atomized liquid to the delivery nozzle.

The wash system of any preceding clause, wherein the fourth valve is a butterfly valve.

The wash system of any preceding clause, wherein the inlet chamber has a first end portion, a second end portion, and a middle portion disposed between the first end portion and the second end portion, the inlet chamber having have an axial direction extending from the first end portion to the second end portion and a radial direction extending perpendicular to the axial direction, and wherein the first end portion and the second end portion have a width defined along the radial direction that is smaller than a width of the middle portion.

The wash system of any preceding clause, wherein the inlet assembly further comprises: a third fluid conduit defining a third fluid passageway for delivering a gas, a third valve disposed in the third fluid passageway; a housing defining an inlet chamber; and an inner wall disposed in the housing to divide the housing into a first chamber in fluid communication with the second fluid passageway and a second chamber in fluid communication with the third fluid passageway, the inner wall defining at least one orifice to place the first chamber in fluid communication with the second chamber; wherein the first fluid conduit is coupled to the housing downstream of the second fluid conduit and the third fluid conduit.

The wash system of any preceding clause, wherein the inner wall is generally conical in shape.

The wash system of any preceding clause, wherein the inlet chamber has a first end portion that is coupled to the delivery nozzle and a second end portion opposite the first end portion, the inlet chamber having an axial direction extending from the first end portion to the second end portion of the inlet chamber and a radial direction extending perpendicular to the axial direction; and wherein the first end portion has a width defined along the radial direction that is smaller than a width of the second end portion.

The wash system of any preceding clause, wherein in the foam washing mode the first valve is open and the second valve and the third valve are closed, and wherein in the liquid washing mode the first valve is closed and the second valve and the third valve are open.

The wash system of any preceding clause, wherein the inlet assembly further comprises: a third fluid conduit defining a third fluid passageway for delivering a gas, a third valve disposed in the third fluid passageway; a housing defining an inlet chamber; and a check valve disposed in the inlet chamber; wherein the second fluid conduit is coupled to the housing downstream of the check valve, wherein the third fluid conduit is coupled to the first fluid conduit, wherein the first fluid conduit is coupled to the housing upstream of the check valve, and wherein the gas atomizes the liquid.

The wash system of any preceding clause, wherein the liquid is a low-pressure liquid.

The wash system of any preceding clause, wherein the gas is a high-pressure gas.

The wash system of any preceding clause, wherein in the foam washing mode the first valve is open and the second valve and the third valve are closed, and wherein in the liquid washing mode the first valve is closed and the second valve and the third valve are open.

The wash system of any preceding clause, wherein the check valve is a first check valve, and wherein the inlet assembly further comprises a second check valve disposed in the second fluid passageway downstream of the second valve, and wherein the second check valve disposed upstream of where the third fluid conduit is coupled to the second fluid conduit.

The wash system of any preceding clause, further comprising: a housing defining an inlet chamber; and a fourth valve disposed in the inlet chamber; wherein the first fluid conduit is coupled to the housing upstream of the fourth valve, and wherein the second fluid conduit is coupled to the housing downstream of the fourth valve.

The wash system of any preceding clause, wherein the fourth valve is a check valve.

The wash system of any preceding clause, wherein the first valve is open and the second valve is closed in the foam washing mode.

The wash system of any preceding clause, wherein the first valve is closed and the second valve is open in the liquid washing mode.

What is claimed is:

1. A wash system for a gas turbine engine comprising:
an inlet assembly comprising:
a housing defining a mixing chamber with a porous structure therein;
a first fluid conduit in fluid communication with a gas source;
a second fluid conduit in fluid communication with a detergent source; and
a third fluid conduit in fluid communication with a liquid source;
a delivery nozzle coupled to the inlet assembly;
a plurality of valves to control fluid flow from the first fluid conduit, the second fluid conduit, and the third fluid conduit into the delivery nozzle; and
a controller configured to actuate the plurality of valves to cause the wash system to switch between a foam washing mode and a liquid washing mode, wherein the inlet assembly delivers foam to the delivery nozzle in the foam washing mode and delivers liquid from the liquid source to the delivery nozzle in the liquid washing mode.

2. The wash system of claim 1, wherein the first fluid conduit defines a first fluid passageway for delivering gas from the gas source, wherein the second fluid conduit defines a second fluid passageway for delivering a detergent from the detergent source, wherein the third fluid conduit defines a third fluid passageway for delivering the liquid from the liquid source, and wherein the plurality of valves includes a first valve in the first fluid conduit, a second valve in the second fluid conduit, and a third valve in the third fluid conduit.

3. The wash system of claim 2, wherein the delivery nozzle comprises a pressure operated valve assembly for controlling foaming of the liquid, the pressure operated valve assembly including:
a retaining wall that extends across the first fluid conduit, the retaining wall having at least one orifice to allow for flow of the gas through the retaining wall into the mixing chamber;
a receiving chamber defined by the retaining wall and a portion of the first fluid conduit, wherein the porous structure that is movable between a first position for the foam washing mode in which at least a portion of the porous structure is disposed within the mixing chamber and a second position for the liquid washing mode in which the porous structure is seated within the receiving chamber; and
a biasing member disposed within the mixing chamber and operatively coupled to the porous structure, the biasing member biasing the porous structure toward the second position.

4. The wash system of claim 3, wherein in the foam washing mode the first valve is open to permit flow of gas through the first fluid passageway, the second valve is open to permit flow of detergent through the second fluid passageway, and the third valve is closed to block flow of fluid through the third fluid passageway; and, wherein in the liquid washing mode the first valve is closed to block flow of gas through the first fluid passageway resulting in the porous structure being displaced adjacent to the retaining wall, the second valve is closed to block flow of detergent through the second fluid passageway, and the third valve is open to permit flow of fluid through the third fluid passageway.

5. The wash system of claim 2, further comprising:
a check valve disposed in the mixing chamber, the porous structure is fixed upstream of the check valve;
wherein the first fluid conduit and the second fluid conduit are coupled to the mixing chamber upstream of the check valve, and wherein the third fluid conduit is coupled to the mixing chamber downstream of the check valve, and wherein in the foam washing mode the first valve and the second valve are open and the third valve is closed; and wherein in the liquid washing mode the first valve and the second valve are closed and the third valve is open.

6. The wash system of claim 2, wherein the gas is a first gas and the gas source is a first gas source, and wherein the wash system further comprises:
a fourth fluid conduit coupled to the third fluid conduit, the fourth fluid conduit defining a fourth fluid passageway for delivering a second gas, the fourth fluid conduit in fluid communication with a second gas source, the plurality of valves further including a fourth valve in the fourth fluid passageway; and
a check valve disposed in the mixing chamber, the porous structure is positioned upstream of the check valve;
wherein the first fluid conduit and the second fluid conduit are coupled to the mixing chamber upstream of the check valve, and wherein the third fluid conduit and the fourth fluid conduit are coupled to the mixing chamber downstream of the check valve.

7. The wash system of claim 6, wherein the check valve is a first check valve and wherein the wash system further comprises:
a second check valve disposed in the third fluid passageway, the second check valve positioned downstream of the third valve and upstream of where the fourth fluid conduit is coupled to the third fluid conduit;
wherein in the foam washing mode the first valve and the second valve are open and the third valve and the fourth valve are closed; and wherein in the liquid washing mode the first valve and the second valve are closed and the third valve and the fourth valve are open resulting in an atomized liquid delivery.

8. A wash system for a gas turbine engine comprising:
an inlet assembly comprising:
a first fluid conduit in fluid communication with a gas source; and
a second fluid conduit in fluid communication with a detergent source;
a delivery nozzle coupled to the inlet assembly, the delivery nozzle having a porous structure disposed therein;
a regulator controlling gas flow into the delivery nozzle, the regulator disposed in the first fluid conduit; and
a controller configured to operate the regulator to cause the wash system to switch between a foam washing mode and a liquid washing mode, wherein the controller sets the regulator to a low pressure in the foam washing mode to generate a foam and sets the regulator to a high pressure in the liquid washing mode to deliver liquid detergent.

9. The wash system of claim 8, wherein the delivery nozzle comprises an outer casing that defines an interior nozzle cavity, the delivery nozzle elongated along a longitudinal axis from a feed end, the feed end of the delivery nozzle coupled to the inlet assembly, the outer casing defining at least one outlet opening, the delivery nozzle further comprising: a first inner wall disposed in the interior nozzle cavity, the first inner wall dividing the interior nozzle cavity into a first chamber that is in fluid communication with the first fluid conduit and a second chamber in fluid communication with the second fluid conduit; and
a second inner wall disposed in the interior nozzle cavity, the second inner wall defining at least a portion of a mixing chamber disposed at a delivery end of the delivery nozzle, the mixing chamber in fluid communication with the first chamber, the second chamber, and the at least one outlet opening, the mixing chamber including the porous structure disposed therein for generating the foam in the foam washing mode.

10. The wash system of claim 9, wherein the delivery nozzle defines an axial direction that extends parallel to the longitudinal axis of the delivery nozzle, a radial direction, and a circumferential direction extending about the axial direction; and wherein the first inner wall of the delivery nozzle extends through the interior nozzle cavity in the axial direction dividing the interior nozzle cavity into the first chamber and the second chamber.

11. The wash system of claim 9, wherein the first inner wall of the delivery nozzle is an annular wall that extends axially through the interior nozzle cavity and is spaced from the outer casing of the delivery nozzle, a first space between the first inner wall and the outer casing defining the first chamber and a second space within an interior of the annular wall defining the second chamber, and wherein the annular wall has a proximal end adjacent to the inlet assembly and a distal end opposite the proximal end, and wherein the distal end of the annular wall includes a plurality of holes in fluid communication with the mixing chamber.

12. A wash system for a gas turbine engine comprising:
an inlet assembly comprising a first fluid conduit defining a first fluid passageway for delivering a foam and a second fluid conduit defining a second fluid passageway for delivering a liquid, the first fluid conduit in fluid communication with a foam source and the second fluid conduit in fluid communication with a liquid source;
a delivery nozzle that is elongated along a longitudinal axis from a feed end to a delivery end, the feed end of the delivery nozzle coupled to the inlet assembly, the delivery nozzle comprising at least one outlet opening;
a plurality of valves for controlling fluid flow into the delivery nozzle, the plurality of valves including a first valve in the first fluid passageway and a second valve in the second fluid passageway; and
a controller configured to actuate the plurality of valves to cause the wash system to switch between a foam washing mode and a liquid washing mode, wherein the delivery nozzle delivers the foam in the foam washing mode and delivers the liquid in the liquid washing mode.

13. The wash system of claim 12, wherein the delivery nozzle comprises:
an outer casing that encloses an interior nozzle cavity, the outer casing including a foam washing opening and a liquid washing opening, a total area of the foam washing opening being larger than a total area of the liquid washing opening; and
a foam washing flap coupled to the outer casing adjacent to the foam washing opening by a spring, the foam washing flap movable between a closed position in which the foam washing flap seals the foam washing opening and an open position in which the foam washing flap is spaced from the foam washing opening, the spring having a biasing force sufficient to bias the foam washing flap to the open position when the first fluid conduit delivers the foam to the interior nozzle cavity in the foam washing mode.

14. The wash system of claim 12, wherein the delivery nozzle comprises:
an outer sleeve having a first plurality of outlet openings and a second plurality of outlet openings, the first plurality of outlet openings having a larger or approximately equal total open area than the second plurality of outlet openings, the outer sleeve having an open end disposed at the feed end of the delivery nozzle and a closed end disposed at the delivery end of the delivery nozzle;
an inner sleeve disposed concentrically within the outer sleeve, the inner sleeve having a third plurality of outlet openings, the inner sleeve and the outer sleeve defining an outer casing of the delivery nozzle that encloses an interior nozzle cavity, the inner sleeve having an open end disposed at the feed end of the delivery nozzle and a closed end disposed at the delivery end of the delivery nozzle; and
a biasing member disposed between the closed end of the outer sleeve and the closed end of the inner sleeve, the biasing member biasing the closed end of the inner sleeve away from the closed end of the outer sleeve;
wherein, in the foam washing mode a flow of the foam from the first fluid conduit compresses the biasing member to align the third plurality of outlet openings with the first plurality of outlet openings; and wherein in the liquid washing mode a flow of liquid from the second fluid conduit compresses the biasing member to align the third plurality of outlet openings with the second plurality of outlet openings.

15. The wash system of claim 12, wherein the delivery nozzle comprises:
an outer sleeve having a window disposed therein; and
an inner sleeve disposed concentrically within the outer sleeve, the inner sleeve having a first plurality of outlet openings and a second plurality of outlet openings, the first plurality of outlet openings having a larger or approximately equal total open area than the second plurality of outlet openings, the inner sleeve and the outer sleeve defining an outer casing of the delivery nozzle that encloses an interior nozzle cavity;
wherein in the foam washing mode the window in the outer sleeve aligned to expose the first plurality of outlet openings in the inner sleeve, and wherein in the liquid washing mode the window in the outer sleeve is aligned to expose the second plurality of outlet openings in the inner sleeve.

16. The wash system of claim 12, wherein the inlet assembly further comprises:
a third fluid conduit defining a third fluid passageway for delivering a gas, a third valve disposed in the third fluid passageway;
a housing defining an inlet chamber; and
a fourth valve disposed in the inlet chamber;
wherein the first fluid conduit is coupled to the housing downstream of the fourth valve, and wherein the second fluid conduit and the third fluid conduit are coupled to the housing upstream of the fourth valve.

17. The wash system of claim 16, wherein the inlet chamber has a first end portion, a second end portion, and a middle portion disposed between the first end portion and the second end portion, the inlet chamber having have an axial direction extending from the first end portion to the second end portion and a radial direction extending perpendicular to the axial direction, and wherein the first end portion and the second end portion have a width defined along the radial direction that is smaller than a width of the middle portion.

18. The wash system of claim 12, wherein the inlet assembly further comprises:
a third fluid conduit defining a third fluid passageway for delivering a gas, a third valve disposed in the third fluid passageway;
a housing defining an inlet chamber; and
an inner wall disposed in the housing to divide the housing into a first chamber in fluid communication with the second fluid passageway and a second chamber in fluid communication with the third fluid passageway, the inner wall defining at least one orifice to place the first chamber in fluid communication with the second chamber;
wherein the first fluid conduit is coupled to the housing downstream of the second fluid conduit and the third fluid conduit.

19. The wash system of claim 12, wherein the inlet assembly further comprises:
a third fluid conduit defining a third fluid passageway for delivering a gas, a third valve disposed in the third fluid passageway;
a housing defining an inlet chamber; and
a check valve disposed in the inlet chamber;
wherein the second fluid conduit is coupled to the housing downstream of the check valve, wherein the third fluid conduit is coupled to the first fluid conduit, wherein the first fluid conduit is coupled to the housing upstream of the check valve, and wherein the gas atomizes the liquid.

20. The wash system of claim 12, further comprising:
a housing defining an inlet chamber; and
a fourth valve disposed in the inlet chamber;
wherein the first fluid conduit is coupled to the housing upstream of the fourth valve, and wherein the second fluid conduit is coupled to the housing downstream of the fourth valve.
